(19) United States
(12) Patent Application Publication
(10) Pub. No.: US 2024/0144119 A1
(43) Pub. Date: May 2, 2024

(54) CANDIDATE-REQUISITION MATCHING BASED ON MACHINE LEARNING MODEL

(71) Applicant: Nomad Health, Inc., New York, NY (US)

(72) Inventors: Liming Zhao, New York, NY (US); Alexander G. Nazem, New York, NY (US); Travis Sanders, New York, NY (US); Julia Karpf, New York, NY (US); Qian Shi, New York, NY (US); Lucas Calero Forero, New York, NY (US)

(21) Appl. No.: 17/976,495

(22) Filed: Oct. 28, 2022

(51) Int. Cl. G06Q 10/06; G06Q 10/10

(52) U.S. Cl. CPC G06Q 10/063112; G06Q 10/1053

(57) ABSTRACT

Provided is a process including: determining, based on a machine learning model, a measure of outcome success for a set of job requisitions, the machine learning model trained to determine measures of outcome success for job requisitions based on a set of job requisition training data, and the set of job requisition training data comprising: a set of historical job requisitions; and job outcomes for the set of historical job requisitions; ranking, based on the measure of outcome success, the set of job requisitions to generate a ranked set of job requisitions; and providing, to a job candidate, one or more job requisitions of the ranked set of job requisitions for selection of a job requisition for application by the job candidate.

### BACKGROUND

In many markets, matching is conducted to fill requisitions with suitable candidates. In the labor market (or “job” market), for example, matching is often conducted to pair job applicants with job openings. In this context, employers often promote job openings in hopes of filling those openings with capable employees, and job applicants often search for and apply for job openings in hope of obtaining a fulfilling job. Employers typically desire a job matching process that maximizes efficiency and profitability in promoting and filling requisitions, and candidates typically desire a job matching process that maximizes personal compensation and fulfillment. Intermediaries (e.g., recruiters) often facilitate matching job applicants and employers by presenting job applicants to employers and/or presenting job requisitions to candidates for job openings. In some instances, the job matching process is accomplished by way of software applications, websites, marketplaces, and the like.

### SUMMARY

The following is a non-exhaustive listing of some aspects of the present techniques. These and other aspects are described in the following disclosure.

Some aspects include application of a machine learning model to requisitions to rank requisitions.

Some aspects include application of a machine learning model to candidates to determine a probability of success for a candidate-requisition pairing.

Some aspects include application of historical requisition-outcome data to train a machine learning model.

Some aspects include application of historical requisition-candidate-outcome data to train a machine learning model.

Some aspects include matching of candidates and requisitions based on the above-mentioned application.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a diagram that depicts a candidate-requisition matching system (“system”), in accordance with one or more embodiments.

FIG. 2 is a diagram that depicts training of a job requisition-based machine learning model, in accordance with one or more embodiments.

FIG. 3 is a diagram that depicts training of a candidate-based machine learning model, in accordance with one or more embodiments.

FIGS. 4A-4C are tables that illustrate example parameters for at least one of a job requisition-based machine learning model, a candidate-based machine learning model, or a combination thereof, in accordance with one or more embodiments.

FIG. 5 is a diagram that illustrates an exemplary method for ranking of requisitions using a machine learning model, in accordance with one or more embodiments.

FIG. 6 is a diagram that illustrates an exemplary method for training a machine learning model to rank requisitions, in accordance with one or more embodiments.

FIG. 7 is a diagram that illustrates an exemplary method for determining a measure of outcome success for a candidate for a requisition, in accordance with one or more embodiments.

FIG. 8 is a diagram that illustrates an exemplary method for training a machine learning model to determine a measure of outcome success for a candidate-requisition instance, in accordance with one or more embodiments.

FIG. 9 is a diagram that illustrates an exemplary method for ranking of applications using a machine learning model, in accordance with one or more embodiments.

FIG. 10 is a diagram that illustrates an example computing system that implements a machine learning model, in accordance with one or more embodiments.

FIG. 11 is a diagram that illustrates an example computing system in accordance with one or more embodiments.

While the present techniques disclosed are susceptible to various modifications and alternative forms, specific embodiments are shown by way of example in the drawings and are described in detail. The drawings may not be to scale. It should be understood that the drawings and the detailed description are not intended to limit the present techniques to the particular form disclosed, but are intended to cover modifications, equivalents, and alternatives falling within the spirit and scope of the present techniques disclosed and defined by the appended claims.

### DETAILED DESCRIPTION

To mitigate the problems described herein, the inventors had to both invent solutions and, in some cases just as importantly, recognize problems overlooked (or not yet foreseen) by others in the fields of machine learning and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described.

Short term employment is often used to describe time-bound jobs that are performed over a given period of time. Short-term positions may be full-time or part-time, but they typically have a specific and binding end date for the employer and worker to consider the job short-term. These types of jobs are sometimes referred to as temporary or fixed-term jobs. Engaging workers on a short-term basis can take various forms, and commonly includes companies use of contract workers (such as independent contractors, freelancers or work-for-hire staffers), which are typically individuals engaged for a specific project or timeframe. Gig work, a type of contract work, typically includes companies use of workers (either employees or contractors) to provide on-demand services for the company or its clients. For example, gig work may include a company receiving a request for a task to be performed from a client (e.g., a request for a personal errand submitted to from an individual to a company by way of a web-based work application) and delegating the task to a gig worker (e.g., a web-based work application assigning the tasks to a gig worker for completion), and the gig worker completing the task for the client on the company's behalf (e.g., the gig worker completing the requested personal errand). Although contract work typically has a predetermined length of service, the length of service often varies from relatively short term (e.g., hour or less gig work) to relatively long term (e.g., year-long teacher contract employment, multi-year long-term medical residency, or the like).

Short term work often relies on relatively short term offers and contracts, which may enable employers to respond quickly to changing needs. As a result, short term work, including contract and gig work, may function as a revolving employment market. For example, because short term positions are relatively short in duration, short term workers may be in search of new opportunities, including time limited employment offers, more frequently than workers in traditional, long-term employment models. In this type of employment market, job requisitions may be offered regularly, and the employers and workers may regularly interact with or otherwise have knowledge of one another. The short-term nursing market is one example of a short-term employment market. In the short-term nursing market hospitals often post short term nursing position (e.g., for nursing jobs lasting hours, days, weeks, or months) and qualified nurses respond and fill those positions. In this market, nurses may move between various nursing positions, often returning to the same hospital or hospital system in different short-term positions. For the sake of explanation, the term “employment” is used herein to encompass both employment and work, e.g., short-term employment, long-term employment, contract work, gig agreements, etc., unless indicated otherwise.

Unfortunately, matching job candidates with job openings can be difficult. For example, it can be difficult to determine which jobs should be presented to a candidate for application, and it can be difficult to determine which applying candidate is best suited for a job. As a result, companies and candidates often spend an inordinate amount of time and effort exploring the short-term job market, and still may not find a suitable candidate for a job.

Provided in some embodiments, is an employment system that facilitates filling job opening with suitable candidates. In some embodiments, the system provides an efficient system for presenting job openings to job candidates and promoting job candidates for job openings. In some embodiments, knowledge of previous interactions is used to improve matching of job candidate with job openings. This may increase the efficiency and effectiveness of job placement, which can, in turn, help employers find better employees for their job openings and help employees find more fulfilling jobs.

In some embodiments, a job requisition model (or “model”) is used to predict a likelihood (e.g., a probability) of a job offering being extended. For example, a model may be used to predict a likelihood of a job offer being extended for a specific job. In some embodiments, a model is used to rank a set of job requisitions based on a likelihood of a job offer being extended within a specific time frame. For example, a model may be used to rank a set of job requisitions based on a likelihood of a job offer being extended and a predicted time to a job offer being extended.

In some embodiments, a model is used to predict a likelihood (e.g., a probability) of a specific job offer (e.g., corresponding to a specific job requisition) being extended to a candidate. For example, a model may be used to predict the probability of a specific job offer being extended to any member of a candidate pool. As another example, a model may be used to predict a likelihood of a specific job offer being extended to a specific candidate. In some embodiments, a model is used to predict a likelihood of a job offer being extended based on job requisition properties. For example, a model may be used to predict a likelihood of a job offer being extended for a job based on job requisition properties including job parameters such as job requisition age, the employer offering the job and the employer's propensity for extending offers in the past, the status of the employer as a client of the candidate pool, the job location, the job specialty, the job rate, the total number of applications previously submitted to the job requisition, etc. In some embodiments, a model is used to predict a likelihood of a job offer being extended based on candidate properties. For example, a model may be used to predict a likelihood of a job offer being extended to a given candidate based on candidate properties including job parameters such as the job requisition age at the time of the candidate's application, the number of applications previous submitted to the job requisition at the time of the candidate's application, the candidate's experience level, the candidate's previous job offers, the candidate's previous rate of job offers, the candidate's location, the candidate's specialty experience, etc. In some embodiments, a model is used to predict, extract, or infer job parameters from job requisitions. For example, a model may employ natural language processing to predict, extract, or infer job parameters from job requisitions. In some embodiments, a model is used to predict, extract, or infer candidate parameters from candidate supplied information. For example, a model may be used to predict, extract, or infer candidate parameters from a candidate application currently submitted (or previously submitted) by a candidate. In some embodiments, a model is used to predict, extract, or infer candidate parameters from candidate interactions with job requisitions. For example, a model may be used to predict, extract, or infer candidate parameters for a candidate based on a determination that the candidate has viewed, selected (e.g., marked as a favorite) or otherwise interacted with a job posting on a website. In some embodiments, a model uses natural language processing to predict, extract, or infer candidate parameters. For example, a model may use natural language processing to predict, extract, or infer candidate parameters from a candidate application.

In some embodiments, a model is used to predict whether a candidate will accept a job offer. For example, a model may be used to predict whether a specific candidate will accept any job offer. As another example, a model may be used to predict whether a specific candidate will accept a specific job offer. In some embodiments, a model may be used to predict whether a specific job offer will be extended to a specific candidate and be accepted by the specific candidate.

In some embodiments, a model is used to rank a set of job requisitions based on a likelihood of a job offer being extended. For example, a model may be used to rank a set of job requisitions based on a likelihood of a job offer being extended within a specific time frame. As a further example, a model may be used to rank a set of job requisitions based on a likelihood of a job offer being extended and a predicted time to a job offer being extended.

In some embodiments, a model is used to provide job requisition rankings to candidates. These types of rankings may be used, for example, to facilitate matching of candidates of a pool of candidates to a set of job requisitions. For example, a model may be used to rank a set of job requisitions based on likelihood of a job offer being extended, and a corresponding ranked order of the job requisitions may be displayed to candidates of a pool of candidates for use in matching candidates of the pool to the set of job requisitions. In some embodiments, a model is iteratively updated based on changes over time, such as changes in the set of job requisitions, new/updated application submissions, etc. In some embodiments, a model is used to update rankings of a set of job requisitions as new candidate applications are submitted for the set of job requisitions. For example, if one or more applications have been submitted or additional job requisitions supplied between a time A and a time B, a ranking of the set of job requisitions at a time A may be different than a ranking of the set of job requisitions at a time B.

In some embodiments, a model is used to match specific candidates to a set of job requisitions. For example, a model may be used to rank a set of job requisitions for a specific candidate and display the job requisitions in ranked order to the specific candidate. In such an embodiment, different candidates may be presented with different rankings of requisitions. For example, a candidate A may receive a different ranked order of the same or different job requisitions than a candidate B. In some embodiments, a model is used to update a ranked order provided to a specific candidate. For example, if an additional application is submitted by candidate B after the ranked listing of a set of job requisitions is displayed to candidate A, the model may generate an updated ranked listing of the set of job requisitions for candidate A taking into account the additional application submitted by candidate B, and the updated ranking of the set of job requisitions may be displayed or otherwise provided to candidate A. Similarly, if the status of an application from candidate B is updated, for instance if candidate B receives a job offer for their application, after the ranked listing of a set of job requisitions is displayed to candidate A, the model may generate an updated ranked listing of the set of job requisitions for candidate A taking into account the additional offer extended to candidate B.

In some embodiments, a model is used to match candidates of a pool of candidates to a set of job requisitions. For example, a model may be used to rank a set of job requisitions and candidates of the pool of candidates may be identified (e.g., by the model, by a matching service, etc.) for the set of job requisitions based on the ranked set of job requisitions. In such an embodiment, candidates may be matched or otherwise identified for the set of job requisitions based on rankings of job requisitions. For example, where a set of job requisitions includes X job requisitions and a pool of candidates for the set of job requisitions includes Y candidates (where X is greater than Y), the first Y of the ranked set of requisitions may be identified as matching. In such an embodiment, the Y candidates may be supplied (e.g., to the respective employers) as matches for the first Y of the ranked set of job requisitions or the Y of the ranked set of job requisitions may be supplied (e.g., to the Y candidates of the candidate pool) as matches for the first Y of the ranked set of job requisitions.

In some embodiments, a model is used to match individual candidates of a pool of candidates to a set of job requisitions. For example, a model may be used to rank a set of job requisitions for each of, some of, or all of the candidates of the candidate pool and provide respective candidate specific sets of ranked job requisitions (e.g., in ranked order) to the respective candidates. In some embodiments, a matcher (e.g., the model or a matching service) matches (or at least attempts to match) each of the candidates to job requisitions to maximize the utility of the candidate job requisition-offer outcome system. The utility may be, for example, a return-on-investment (ROI) utility. The utility may be maximized per candidate. In some embodiments, a model may provide individually ranked job requisitions to each of the candidates based on a maximization of utility for each candidate. For example, a model may optimize candidate and job requisition matching based on full employment goals (e.g., a job requisitions for substantially all candidates wherein the likelihood of an offering being extended is maximized over the candidate), based on total compensation goals (e.g., matching a candidate with a job offer for which the compensation is the highest for which the probability of a job offer being extended at least exceeds a threshold), etc. For the sake of discussion, consider a scenario where candidate A has a probability X of being offered a job requisition α at a compensation level 1 and a probability Y of being offered a job requisition β at a compensation level 2. In some embodiments, such as those where probabilities are maximized, a model may match and recommend (or otherwise present) the job requisition α to the candidate A if probability X is greater than probability Y. In some embodiments, such as those where compensation is maximized (e.g., with at least a minimum probability of an offer associated with compensation), a model may match and recommend the job requisition β to candidate A if a compensation level 2 is greater than compensation level 1 where X is greater than Y but where Y is greater than a threshold. In some embodiments, such as those in which a weighted combination of compensation and associated probability is maximized, a job requisition may be recommended to a candidate based on an average of compensation levels weighted according to probability of a job offer being extended. For example, a model may recommend a job requisition α to candidate A if compensation level 1 multiplied by the probability X is greater than compensation level 2 multiplied by the probability Y. It will be appreciated that these are examples, and other optimization functions for candidate matching may be employed. For example, compensation level is provided as an example and other financial or non-financial incentives (e.g., client contractual obligations, finders fees, etc.) may be used alone or in combination for matching.

In some embodiments, a model may provide individually ranked job requisitions to each of the candidates based on a maximization of utility over the pool of candidates. For example, a model may be used to match a pool of candidates to a set of job requisitions. In some embodiments, a model may provide individually ranked job requisitions to each of the candidates based on a maximization of utility for the candidate pool. Individually-ranked job requisitions based on a maximization of utility for the candidate pool may be different than individually-ranked job requisitions based on a maximization of utility for each candidate. For example, a model may be used to rank specific candidates (e.g., which may be some, a subset of, active candidates, all, substantially all, etc. candidates of the candidate pool) of the candidate pool for a set of job requisitions and provide the set of job requisitions together to one or more candidates in ranked order to a model (or matching service). The candidates may be ranked for each of the set of job requisitions (e.g., ranked by probability of a job offer being extended). The set of job requisitions may also or instead be ranked (e.g., ranked by probability of a job offering being extended for the best match candidate, ranked by average probability of a job offering being extended for the one or more candidates, ranked by a weighted average of the probability of a job offering being extended and the compensation level, etc.).

In some embodiments, a model (or a matching service)—which may be the same or a different model than the model used to rank—may be employed to match (or at least attempt to match) the set of job requisitions to candidates of the pool of candidates to maximize the utility of the candidate pool-set of job requisitions-offer outcome system. For example, a model may optimize candidate and job requisition matching based on full employment goals (e.g., a job requisitions for substantially all candidates wherein the likelihood of an offering being extended is maximized for the candidate pool as a whole), based on total compensation goals (e.g., matching a candidate with a job offer for which the compensation is the highest for the candidate pool as a whole and for which the probability of a job offer being extended at least exceeds a threshold), etc. As an example, consider a scenario where a candidate A has a probability W of being offered a job requisition α at a compensation level 1 and a probability X of being offered a job requisition β at a compensation level 2 and if a candidate B has a probability Y of being offered a job requisition a at a compensation level 1 and a probability Z of being offered a job requisition β at a compensation level 2. In an embodiment where, for example, candidate pool probability is maximized, a model may suggest the job requisition α to the candidate A if W is greater than Y. In this case, the model may also suggest the job requisition β to candidate A if, for example, X is greater than Z. In an alternative, the model may instead suggest the job requisition β to candidate B, whether or not X is greater than Z, for example, based on a rule or determination that candidate A cannot accept both job requisition α and job requisition β. In an embodiment where, for example, candidate pool compensation is maximized (e.g., with consideration of relative and minimum probabilities of an offer), the model may recommend the job requisition α to candidate A if compensation level 1 is greater than compensation level 2 and W is greater than Y. In this case, the ROI model may further suggest the job requisition β to candidate B, if, for example, the probability Z is greater than a threshold. In some embodiments, a model may determine a relative probability value (e.g., a differential probability value) for each of the job requisitions, and recommend job requisitions to candidates based on the relative likelihood of a job offer being extended to maximize probabilities of jobs being extend for the multiple candidates. For example, if both candidate A and candidate B are relatively likely to have a job offer extended for the job requisition α (e.g., W˜Y), but candidate B is more likely to have a job offer extended for the job requisition β (e.g., Z>X), then the model may suggest job requisition β for candidate B and job requisition α for candidate A. In some embodiments, a model employs a weighted average (or other optimization function) to maximize probabilities or compensation of job offers for a candidate pool. For example, a model may consider various combinations of probabilities and compensation for job offers to the candidates in a candidate pool (e.g., products of probabilities and compensation for a set of potential job offers across the pool of candidates), and select a combination that maximizes a total of the products of probabilities and compensation.

In some embodiments, a model prioritizes a subset of job requisitions. For example, a model may prioritize matching candidates with job requisitions belonging to (or otherwise corresponding to) client employers or other requisition suppliers who may have a contractual or preferential relationship with the model supplier or matching service.

In some embodiments, a model provides one or more matched job requisitions to a candidate, in ranked or unranked order. In some embodiments, a model provides matched job requisitions for which a likelihood of an offer being extended is above a threshold, provides all job requisitions, provides a subset of job requisitions, provides additional job requisitions based on input from the candidate, etc.

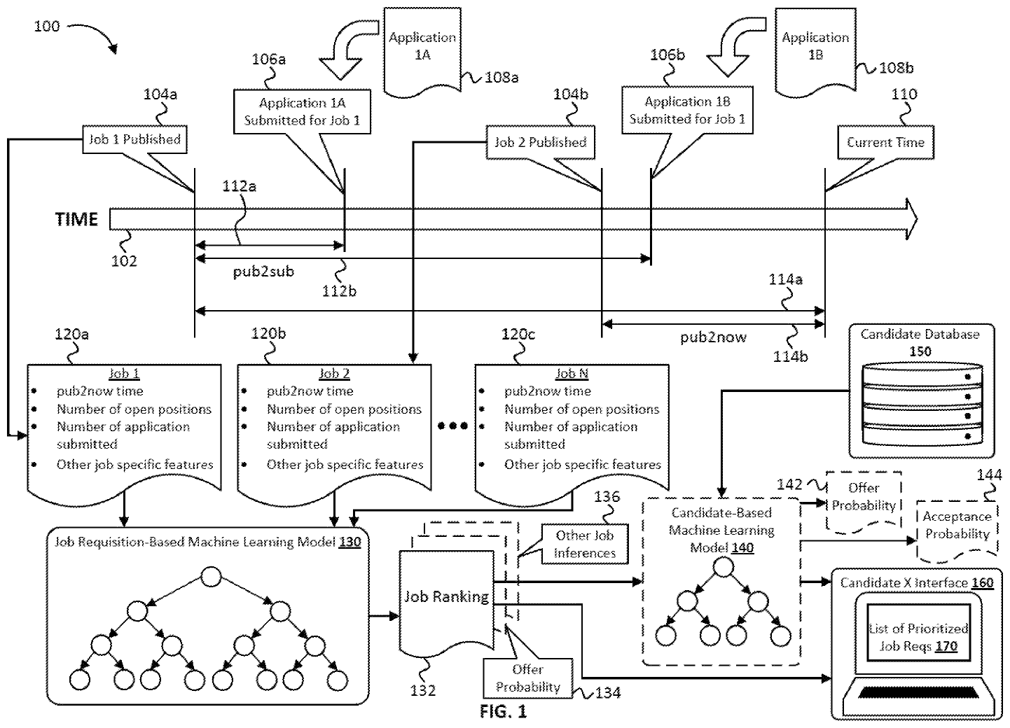

FIG. 1 is a diagram that depicts a candidate-requisition matching system (“system”) 100 in accordance with one or more embodiments. In the illustrated embodiment, the system 100 includes a job requisition-based machine learning model (“requisition model”) 130 and a candidate-based machine learning model (“candidate model”) 140. The requisition model 130 may be used, for example, for ranking and recommending job requisitions. The candidate model 140 may be used, for example, for ranking and recommending job requisitions for a candidate.

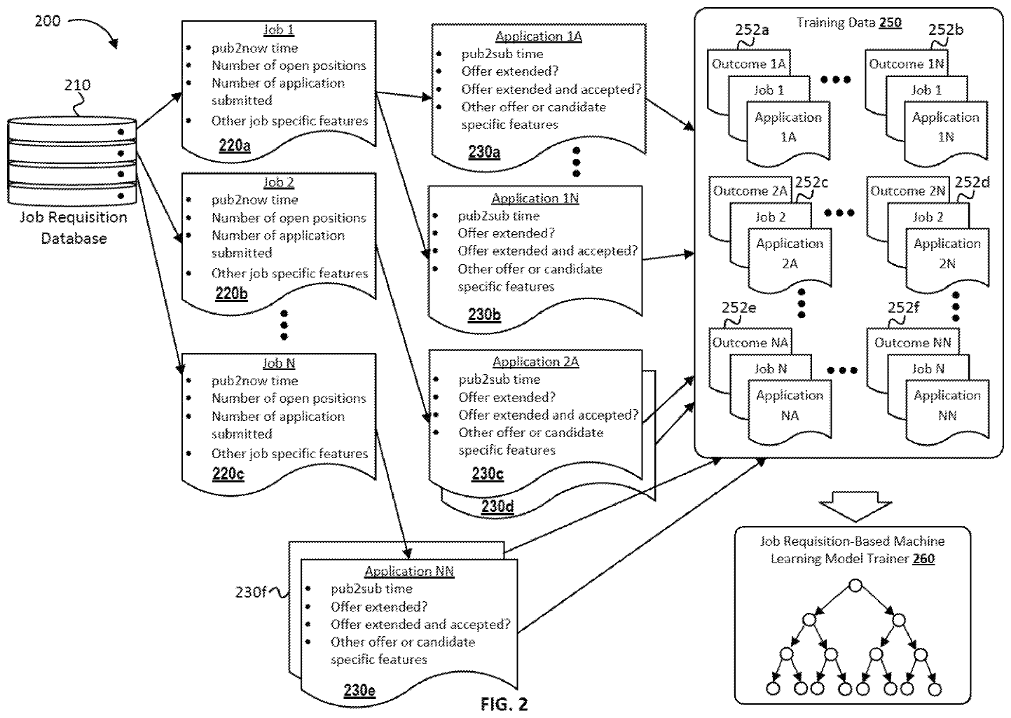

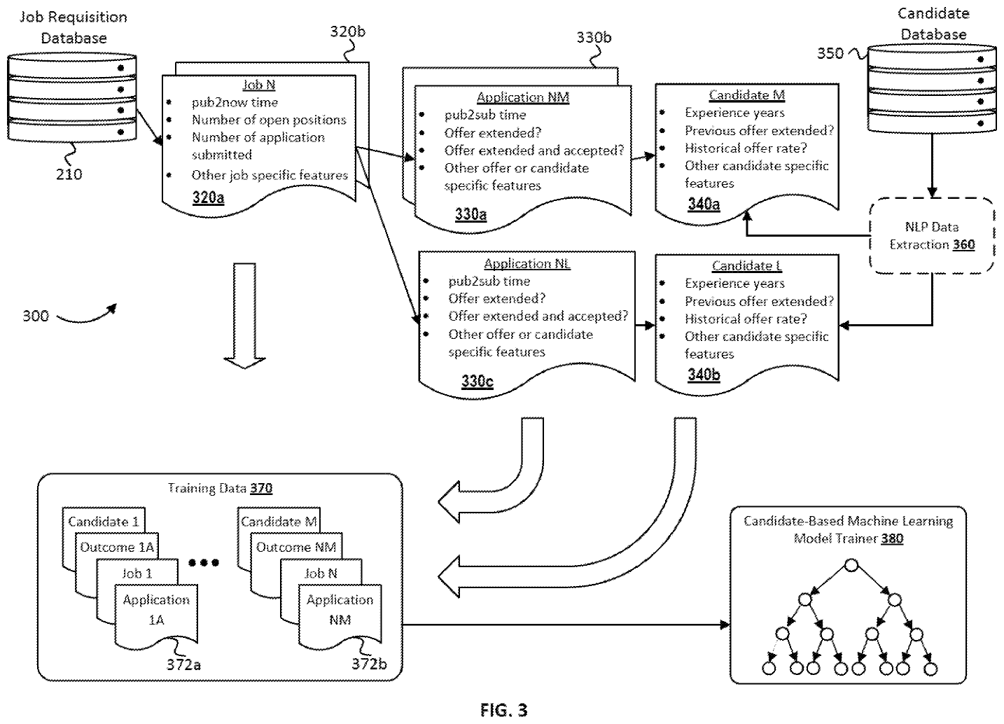

In some embodiments, the requisition model 130 is trained by a job requisition-based machine learning model trainer. For example, the requisition model 130 may be trained by the job requisition-based machine learning model trainer 260 (described in more detail with reference to at least FIG. 2). In some embodiments, the candidate model 140 is trained by a candidate-based machine learning model trainer. For example, the candidate model 140 may be trained by the candidate-based machine learning model trainer 380 described in more detail with reference to at least FIG. 3).

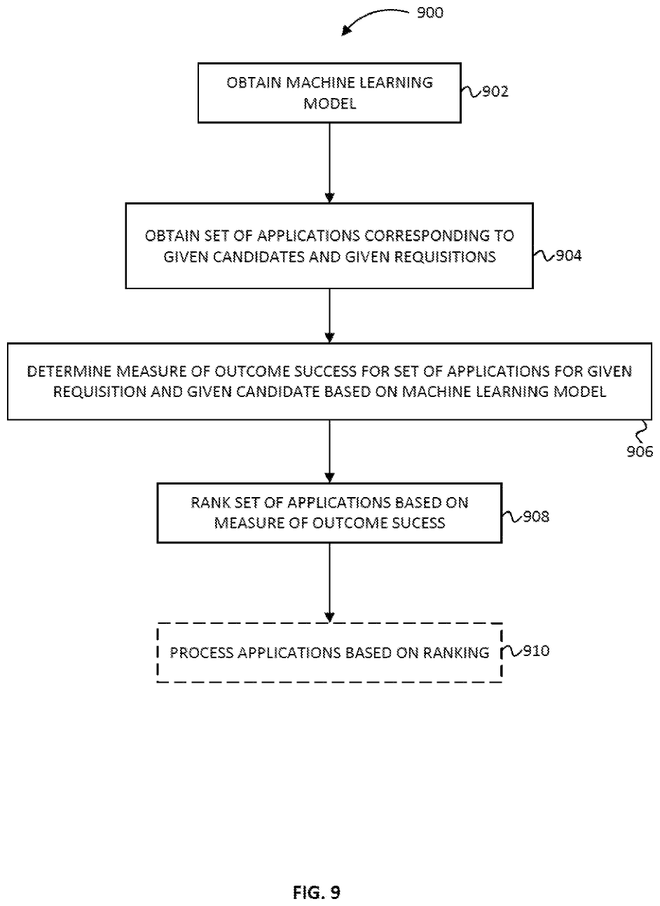

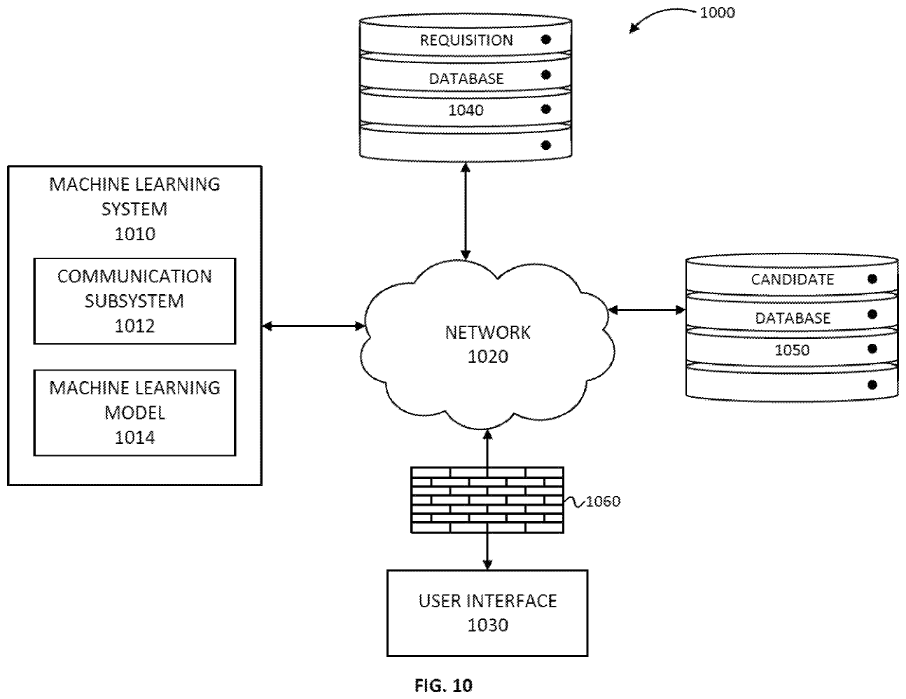

In some embodiments, the candidate-requisition matching system 100 is deployed in a computing system. For example, the candidate-requisition matching system 100 may be deployed in a computing system, such as the computing system 900 (described in more detail with reference to at least FIG. 9) or the computing system 1000 (described in more detail with reference to at least FIG. 10).

Referring to FIG. 1, the candidate-requisition matching system 100 is described with reference to a job requisition-application timeline 102. In the illustrated embodiment, publishing events 104a and 104b occur at first and second times, respectively (as represented by the vertical lines), with the requisition publishing event 104a corresponding to a time of publishing of a job 1 120a, and the requisition publishing event 104b (which occurs after the requisition publishing event 104a) corresponding to a time of publishing of a job 2 120b. The requisition publishing events 104a and 104b may, for example, each correspond to publishing of a respective job requisition by an employer or job service. The publishing of a job requisition by an employer or job service may be an event that results in input of the job requisition into the candidate-requisition matching system 100 for input or detection of the job requisition by the job requisition-based machine learning model 130. For example, the publishing of a job requisition may include a push (or other active sending) of a job requisition to a job candidate (e.g., a matching service pushing a job requisition to a job candidate) or a pull (or other active receipt) of a job requisition that results in input or detection of the job requisition by the job requisition-based machine learning model 130. The requisition publishing events 104a and 104b may each be associated with a respective publishing time (e.g., a time stamp that corresponds to a time at which the associated event occurred) or an age or “pub2now” time (e.g., an amount of time between a publishing event and a given time, such as a current time 110). For example, each of the requisition publishing events 104a and 104b may occur at a respective first and second time, the pub2now time for the requisition publishing event 104a may be the span of time from the first time to the current time 110 (represented by the line 114a), and the pub2now time for the requisition publishing event 104b may be the span of time from the second time to the current time 110 (represented by the line 114b). For historical publishing events, such as those used to train the job requisition-based machine learning model 130, pub2now may be a time between the publishing event and a given “reference” time (which may not be the current time). In such an embodiment, the reference time may be used in place of the time labeled current time 110 in FIG. 1. For example, for publishing events included in training data, a pub2now time for a publishing event may be determined as a time between the publishing event and a reference time (e.g., a second time that occurs sometime after some or all of the published events in the training data). The reference time may be a “snapshot” time, when from which various ages (e.g., pub2now) times are determined. The reference time may be a time when a job offer is extended, a time when a new candidate submits an application to another job requisition, etc.

In some embodiments, the pub2now time for an event is defined by a time value (or time value proxy) corresponding to the span of time between a time of occurrence of the event and a “current time”, which may be defined as a time when the candidate-requisition matching system 100 becomes aware of the event. For example, an employer 1 may publish a job 1 120a corresponding to the requisition publishing event 104a on its own website at a given time (e.g., with or without a timestamp), subsequent to the event the website may be scraped for data (e.g., by a data acquisition system) to identify published data corresponding to job 1 120a, the published data corresponding to job 1 120a may be input into the job requisition-based machine learning model 130, and the job requisition-based machine learning model 130 may affix an acquisition time stamp to the job 1 120a. The acquisition time stamp may, for example, correspond to the time that the published data corresponding to job 1 120a was scraped from the website, or the time that the published data corresponding to job 1 120a is input into the job requisition-based machine learning model 130. In such an embodiment, age may correspond to the amount of time between the given time of the publishing of job 1 120a on the employer website and the acquisition time stamp of the job 1 120a affixed by the job requisition-based machine learning model 130.

In some embodiments, the pub2now for a requisition publishing event is reset by a reoccurrence of a requisition publishing event. For example, if a job requisition associated with requisition publishing event 104a is removed or cancelled and is republished as the job requisition associated with “new” job requisition event 104b, the pub2now for the job requisition may be updated from that of 114a to 114b. In some embodiments, a job requisition that is republished may be associated with pub2now for some or all of the published events. For example, a job requisition that has been published three times may include pub2now scores for each of some or all of the three job requisition publishing events.

In some embodiments, the job requisition-application process includes application submission events. For example, in the illustrated embodiment, the job requisition-application timeline 102 includes application submission events 106a and 106b. The application submission events may correspond to submission of an application by a candidate to the candidate-requisition matching system 100, to the submission of an application by the candidate to an employer or requisitioner of a job requisition, to the submission of an application by the candidate-requisition matching system 100 to an employer or requisitioner of a job requisition, etc. For example, in the illustrated embodiment, application submission event 106a corresponds to the submission of application 1a 108a (e.g., submitted in response to the requisition publishing event 104a for job 1 120a), and application submission event 106b, (occurring after application submission event 106a) corresponds to the submission of application 1b 108b (e.g., submitted in response to requisition publishing event 104a for job 1 120a). Application submission events may be associated with an application time (e.g., a time stamp) or a time difference between a time stamp or time counter of the requisition publishing event 104a. For example, the application submission events 106a and 106b may be associated with an application time (e.g., a time stamp) or alternatively or in addition may include a time difference between a time stamp or time counter of the requisition publishing event 104a.

In some embodiments, a “submission” age is determined, which corresponds to an age of the job requisition at the time of an application submission event. For example, the submission age of the requisition publishing event 104a at the application submission event 106a and 106b may correspond to an age of the job requisition at the time of the submission or “pub2sub” time 112a and 112b, respectively. The submission events 106a and 106b may each be associated with a respective submission time (e.g., application submission time stamp). The submission events 106a and 106b may also be associated with a respective publishing time (e.g., job publishing time stamps for publishing events 104a and 104b, respectively). For example, pub2sub 112a may correspond to the time difference between the requisition publishing event 104a of the job 1 120a and the application submission event 106a of application 1a 108a. Further, pub2sub 112b may correspond to the time difference between the requisition publishing event 104a of the job 1 120a and the application submission event 106b of application 1b 108b. In some embodiments, the pub2sub (e.g., as a numerical value, as a data range, as a time, etc.) may be appended to or otherwise associated with the application of the application submission events. For example, the pub2sub 112a and 112b may be appended to application submission events 106a and 106b and/or the application 1a 108a and 1b 108b, respectively. The pub2sub may be unique for each application submitted in an application submission event in response to a requisition publishing event. For example, sub2sub 112a and sub2sub 112b may each be uniquely calculated for the respective application submission events 106a and 106b in response to the respective requisition publishing events 104a and 104b.

In some embodiments, the job requisition-based machine learning model operates on job requisitions to provide job rankings. For example, the job requisition-based machine learning model 130 may operate on job requisitions, such as those corresponding to the job 1 120a, the job 2 120b, and a job N 120c to provide job rankings. The job requisition-based machine learning model 130 may, for example, operate on individual job requisitions, e.g., as they are acquired by the job requisition-based machine learning model 130, or may operate on a set of job requisitions. In some embodiments, the input into the job requisition-based machine learning model 130 includes one or more job requisitions and includes information about the one or more job requisitions or the one or more job requisitions tagged or otherwise identified with their corresponding information. For example, the job requisition-based machine learning model 130 can operate on one, some, or all, of the job requisitions corresponding to the job 1 120a, the job 2 120b, and the job N 120c.

In some embodiments, the job requisitions-based machine learning model operates on the same or substantially the same information from each of the job requisitions. For example, the job requisition-based machine learning model 130 may operate on the same or substantially the same type of information from each of the job requisitions for the job 1 120a, the job 2 120b, and the job N 120c. The job requisition-based machine learning model 130 may include or be in communication with a data standardizer or other data cleaning program or apparatus which may standardize the information associated with each of the job requisitions. In some embodiments, the job requisition-based machine learning model operates on differing available information from each of the job requisitions. For example, the job requisition-based machine learning model 130 may operate on different types of information, such as any information available, for each of the job requisitions corresponding to the job 1 120a, the job 2 120b, and the job N 120c. For example, the job 1 120a may include information about number of open positions, while job N 120c may not include information about number of open positions, and thus, the job requisition-based machine learning model 130 may use information about number of open positions the for job 1 120a and use other types of information for job N 120c, such as number of applications submitted, location of job, employer or requisitioner of job, job start date, job duration, job specialty, or other job parameters (besides number of open positions) for job N 120c. In another example, the job requisition-based machine learning model 130 may determine that a job which does not explicitly state a number of open positions corresponds to one open position. In another example, the job requisition-based machine learning model 130 may operate on the job N 120c without information about number of open positions.

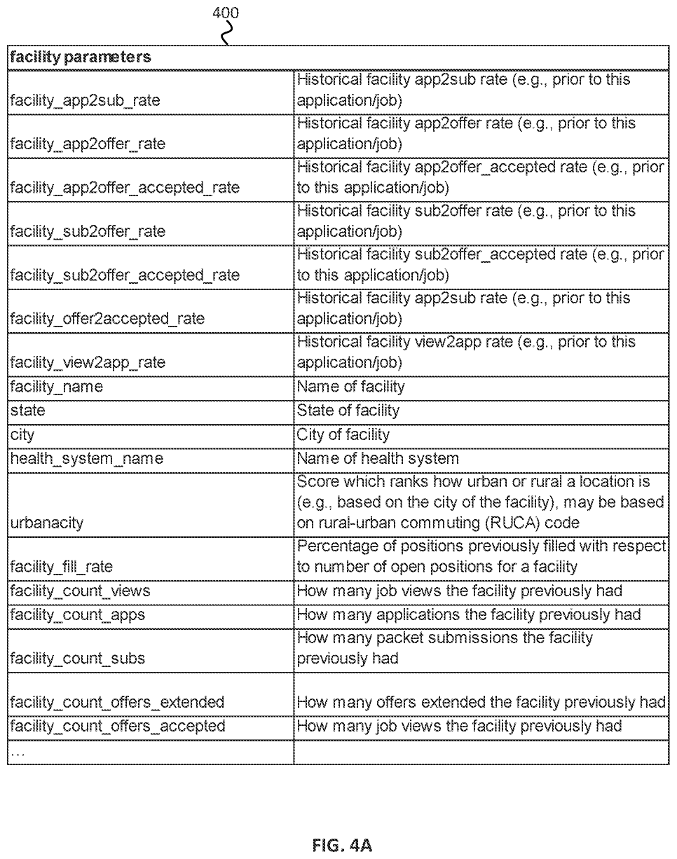

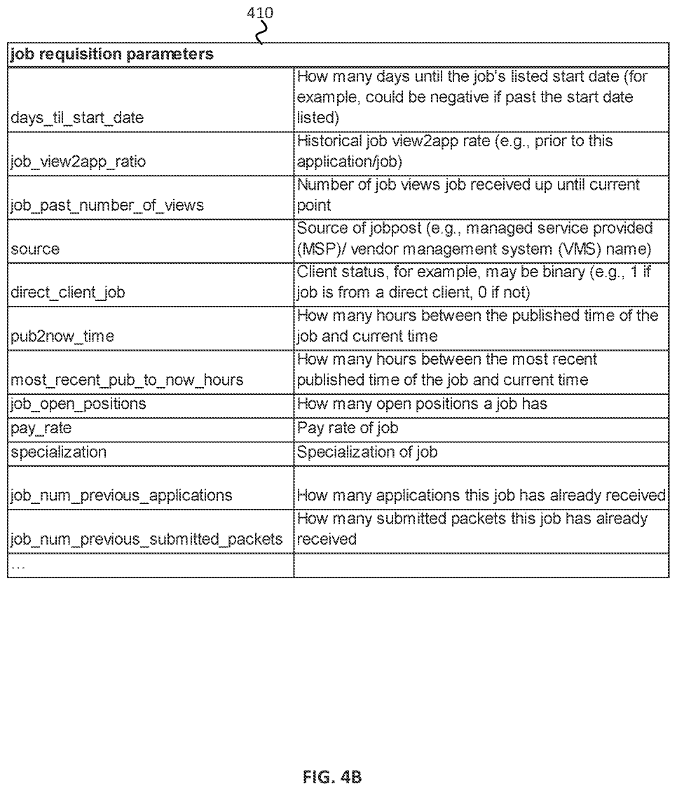

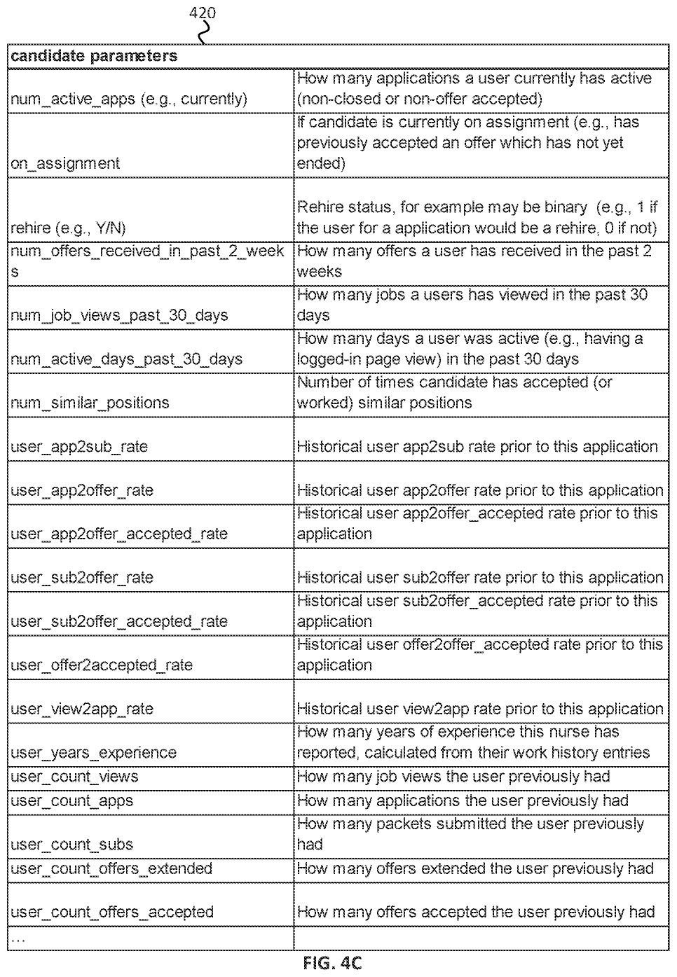

In some embodiments, the job requisition-based machine learning model operates on job information. For example, the job requisition-based machine learning model 130 may operate on job information comprising pub2now, number of open positions, number of applications submitted, location of job, employer or requisitioner of job, job start date, job duration, job specialty, other job parameters, etc. Further example parameters are described hereafter in reference to FIGS. 4A-4C. Based on the job requisitions and accompanying job information, the job requisition-based machine learning model 130 may output a ranking of the set of jobs or job requisitions. In some embodiments, the output of the job requisition-based machine learning model is a ranking of the job requisitions. For example, the output of the job requisition-based machine learning model 130 may include a job ranking 132, which may comprise an ordinal ranking of the job requisitions (or corresponding jobs) which were input into the job requisition-based machine learning model 130. The job requisition-based machine learning model 130 may output the job ranking 132 which includes all or substantially all of the jobs or job requisitions which were input or which includes a subset of the jobs or job requisitions which were input into the job requisition-based machine learning model 130. For example, the job requisition-based machine learning model 130 may determine that one or more job or job requisition is not a valid job requisition or has a probability below a minimum threshold for a job offer being extended and exclude said job from the job ranking 132. In some embodiments, the job requisition-based machine learning model also outputs a job offer likelihood for one or more of the job requisitions. For example, the job requisition-based machine learning model 130 may output a job offer likelihood (e.g., an “offer probability 134”) for a job requisition, a set of job requisitions of the job ranking 132, or a subset of the job requisitions of the job ranking 132. In another example, the job requisition-based machine learning model 130 may output a probability that a job offer is extended to a next submitted application, for an application submitted in response to the job requisition. In some embodiments, the job requisition-based machine learning model outputs a job offer likelihood. For example, the job requisition-based machine learning model may output the job ranking 132 or the offer probability 134, where the offer probability 134 may be used to generate the job ranking 132 or may be used as is. In some embodiments, a job requisition-based machine learning model outputs additional inferences. For example, the job requisition-based machine learning model 130 may also output other job inferences 136 (which may be inferences, predictions, probabilities, binary classifications, etc.). The other job inferences 136 may include a predicted or average time from application submitted to job offer extended, etc. In some embodiments, the job requisition-based machine learning model 130 outputs a job acceptance likelihood (e.g., an acceptance probability) for a job requisition, with or without consideration of a specific application and/or candidate. For example, the job requisition-based machine learning model 130 may output a probability that a job offer is accepted in response to a next submitted application, for an application submitted in response to the job requisition.

In some embodiments, the job requisition-based machine learning model 130 weights job information for use in generating output information, such as a ranking of a set of jobs or job requisitions. The weighting of various job information may depend on the training of the model, including instances where the weighting of some job information may be counter intuitive. In an illustrative example, job information which indicates a job requisition may be popular (e.g., with candidates, with matching services, based on number of applications known to have been submitted, based on number of “views” such as via a link to a website, etc.) may cause a relative ranking of a job requisition to decrease. Such job information may indicate more applications may be submitted for such as job requisition and that receiving a job offer based on an application may be less likely. In some embodiments, job information is weighted such that a job is ranked lower or higher than similar jobs, where similar jobs may be jobs which have similar job information except for the specific job information described (e.g., which may share pieces of job information and vary substantially only in the identified piece of job information). For example, a job requisition having a relatively higher pay rate may be ranked lower than a job requisition having a relatively lower pay rate. This may be correlated to popularity, where, for example, a job requisition with a higher pay rate is expected to be more popular and competitive, lending itself to a lower likelihood of extending an offer to a given candidate. In another example, a job requisition associated with a relatively popular facility location (which may include a facility located in a more popular location) may be ranked lower than a job requisition associated with a relatively less popular facility location. Popularity of a facility (or of a location) may, for example, be determined based on number of applications submitted, number of views such as via a link to a website, etc. The popularity of the facility (or location) may be correlated to popularity of a job requisition, where a job requisition for a job located at a more popular facility (or location) may be expected to be more popular. In yet another example, a job requisition that has a relatively high number of previously submitted applications may be ranked lower than a job requisition with a relatively lower number of previously submitted applications. The popularity of a job requisition with one hundred previously submitted applications may be considered greater than the popularity of a job requisition with one previously submitted application. In another example, a job requisition for a job in a relatively more popular specialization may be ranked lower than a job requisition in a relatively less popular specialization. The popularity of a specialization may be determined, for example, based on a number of applications submitted, number of views such as via a link to a website, etc., for jobs associated with the specialization. The popularity of a job requisition may be correlated to the popularity of its specialization, where, for example, job requisitions in a more popular specialization are expected to be more popular.

The job requisition-based machine learning model 130 may also determine different weightings (e.g., unexpected weightings), where unexpected correlations, such as those between popularity, number of applications, etc., are determined. For example, a job requisition may appear popular (e.g., have a high number of views) but have relatively few applications. Such a case may arise, for example, if the job requisition contains humorous or other content which causes sharing of the job requisition but dissuades candidates from submitting applications for the job requisition. In another example, a facility for a job requisition may experience a change in popularity, which may be due to, for example, a change in ownership, word-of-mouth, etc. causing a facility which has been popular (or unpopular) to become unpopular (or popular). In some embodiments, the job requisition-based machine learning model 130 may detect job requisitions for which the model ranking is inaccurate or for which the model ranking is not reflective of relative popularity. For example, the job requisition-based machine learning model 130 may output an alert for a job requisitions, facility, location, etc. when it has determined that the current model parameters are mismatched for the respective job requisition, facility, location, etc. The job requisition-based machine learning model 130 may, for example, alert the provider of the job requisition, facility operator, operators of facilities in a location, etc. that the job requisition-based machine learning model 130 indicates a problem (for example, a humorously incorrect pay rate, a humorous misspelling, etc.) or change in market conditions (e.g., a decrease in popularity of a location due to legislation, a decrease in popularity of a facility due to an administrative decision, etc.). The job requisition-based machine learning model 130 may determine a cause of a problem or change in market conditions.

In some embodiments, the job requisition-based machine learning model 130 may weight other example job information, which may be included as feature values. This may be used, for example, to output information, such as ranking of a set of jobs or job requisitions. In another illustrative example, the job requisition-based machine learning model 130 may rank a job requisition relatively high based on a higher historical offer rate (e.g., a sub2offer rate) for the facility of the job requisition with respect to similar facilities. An offer rate for a job requisition may be correlated with a historical offer rate for the facility of the job requisition. In another example, the job requisition-based machine learning model 130 may rank a job requisition relatively high for a candidate currently on assignment at the facility of the job requisition, with respect to job requisitions at other facilities. An offer rate for a job requisition may be relatively high for a candidate that the facility has previously hired, is currently on assignment with, etc. This may be because the facility is considered familiar with the candidate, that it is considered easier administratively to hire a returning candidate, etc. In yet another example, the job requisition-based machine learning model 130 may rank a job requisition (or candidate) relatively high for a candidate with relatively high historical offer rate (e.g., a sub2offer rate) with respect to other candidates. A candidate with a relatively high offer rate may, for example, be expected to maintain a high offer rate. Moreover, this may indicate that the candidate is well qualified. In another example, the job requisition-based machine learning model 130 may rank a job requisition relatively low for a job requisition with a longer pub2now time. This may be correlated to an increase in number of applications, and thus a decrease in job offer rate for any respective application, over time.

In some embodiments, the job requisition-based machine learning model 130 operates on candidate applications. For example, the job requisition-based machine learning model 130 may rank (or may include a module that ranks) submitted applications. The job requisition-based machine learning model 130 may filter applications. The job requisition-based machine learning model 130 may operate in a backlog grooming operation or similar for application processing. In some embodiments, the job requisition-based machine learning model 130 may operate on a set of applications which have been received from candidates but have not yet submitted to job requisition supplies yet (e.g., to facilities, to hospital systems, etc.). In some embodiments, the job requisition-based machine learning model 130 may operate on applications as they are received, on batched applications, only if the number of unprocessed applications exceeds a threshold, etc. In some embodiments, the job requisition-based machine learning model 130 may perform a filtering (e.g., pre-cleaning) of applications, for example, to remove applications with incomplete fields, with incomplete information in fields which have been identified as critical (for example, name, certification, etc.), etc. In some embodiments, the job requisition-based machine learning model 130 performs filtering based on candidate information. For example, the job requisition-based machine learning model 130 may remove applications to a facility that correspond to candidates the facility has indicated are on a block list (such as previously terminated candidates, candidates engaged in active litigation against the facility, etc.). In some embodiments, the job requisition-based machine learning model 130 removes applications that correspond to candidates with a job rate (e.g., a job offer extension rate or job offer acceptance rate) below a threshold after at least a given number of associated job events. For example, applications from a candidate with a job offer extension rate of approximately zero (e.g., less than 1%) may be removed, where the candidate has submitted greater than a threshold number of applications (e.g., more than 80 applications). Likewise, applications from a candidate with a job offer acceptance rate of approximately zero (e.g., less than 5%) may be removed, where the candidate has been extended greater than a threshold number of job offers (e.g., more than 20 job offers).

In some embodiments, the job requisition-based machine learning model 130 may rank (or include a module that ranks) submitted applications for a job requisition, such as after a filtering operation. In some embodiments, the job requisition-based machine learning model 130 determines a likelihood of a job offer being extended for an application as it is received for a job requisition. In some embodiments, the job requisition-based machine learning model 130 determines a ranking for a set of applications received for a job requisition. In some embodiments, the job requisition-based machine learning model 130 evaluates one or more applications based on the application itself (e.g., information included within the application, such as candidate provided work experience). In some embodiments, the job requisition-based machine learning model 130 evaluates applications based on candidate information not included in the application, such as a historical job offer extension rate, which may be acquired from a database, determined by the job requisition-based machine learning model 130, etc. For example, the job requisition-based machine learning model 130 may compare candidates to a block list stored in a database, where, for example, a candidate on the block list may be block from being considered for the associated job. In another example, the job requisition-based machine learning model 130 operates on a job requisition ranking produced for the candidate before the application was submitted for the respective job requisition.

In some embodiments, the job requisition-based machine learning model 130 prioritizes applications, which may then be automatically or manually submitted to facilities, locations, hospital systems, etc. For example, the job requisition-based machine learning model 130 may prioritize applications for a specific job requisition based on a ranking of applications for the respective job requisition. In another example, the job requisition-based machine learning model 130 may prioritize applications with a likelihood of success above a threshold, or ranked by the determined likelihood of success, for multiple job requisitions at substantially the same time. The job requisition-based machine learning model 130 may, for example, first process applications with a high likelihood of success, followed by applications with less likelihood of success, etc.

In some embodiments, the job requisition-based machine learning model 130 creates packet (e.g., of information for transmittal), such as of application and/or candidate information to be provided to an employer or facility in response to a job requisition. In some embodiments, the job requisition-based machine learning model 130 is in communication with a program that creates packet to be provided to the employer or facility in response to a job requisition. In some embodiments, the job requisition-based machine learning model 130 increases efficiency of packet creation by identifying applications and/or candidates that are more likely to be successful for a job requisition and causing packets corresponding to those applications and/or candidates to be prioritized (e.g., created first, transmitted first, created more often, etc.).

In some embodiments, the output of the job requisition-based machine learning model 130 is provided to a candidate. For example, the output of the job requisition-based machine learning model 130 may be delivered to one or more candidate interfaces, depicted as candidate X interface 160. The candidate interface may be, for example, a website, an application portal, or other interactive interface (e.g., a dashboard), or an email (including a daily newsletter, weekly summary, etc.), a text message, or one-way notification. In some embodiments, the output of a job requisition-based machine learning model 130 is a list of prioritized job requisitions. For example, the output of the job requisition-based machine learning model 130 may be a list of prioritized job requisitions 170, delivered via the candidate X interface 160. The list of prioritized job requisitions 170 may be presented in ranked order, may be presented with a likelihood of an offer being extended for at least a subset of the job requisitions, or may be displayed or provided in any appropriate manner.

In some embodiments, the output of the job requisition-based machine learning model 130 prioritizes displaying job requisitions with a higher likelihood of a job offer being extended over job requisitions with a lower likelihood of a job offer being extended. For example, such prioritization may be accomplished by displaying prioritized job requisitions more prominently (e.g., at the top of a webpage, above of lower priority job requisitions), displaying prioritized job offers more frequently (e.g., at the top of multiple pages of a website, above lower priority job offers), etc. In some embodiments, such prioritization may be enabled by default, such as regardless of any other filters applied to job requisitions. For example, such prioritization may be used to rank jobs even if other search criteria are used—such as location, specialization, etc., where jobs with a relatively high likelihood of a job offer being extended are displayed before jobs with a relatively better match to search criteria. In an illustrative example, a location search criterion may be used in combination with such prioritization and job requisitions may be ranked in the following order: (1) job in desired location with high likelihood of job offer being extended; (2) job close to desired location with high likelihood of job offer being extended; (3) job in desired location with low likelihood of job offer being extended, etc., where relative weight between search criterion and likelihood of a job offer being extended may vary between search criteria.

In some embodiments, the output of the job requisition-based machine learning model 130 is delivered to another model (or matching service). For example, the output of the job requisition-based machine learning model 130 may be delivered to a candidate pool model or candidate matching service, instead of or in addition to delivery to one or more candidate. The output of the job requisition-based machine learning model 130 may be delivered to a recruiting service or recruiter.

In some embodiments, the job requisition-based machine learning model 130 operates independently of candidate information. For example, the job requisition-based machine learning model 130 may be candidate agnostic. That is, the job requisition-based machine learning model 130 may operate upon job requisition information and not upon application information or candidate information. This may be helpful, for example, to promote jobs to candidates generally. For example, a set of 100 job requisitions may be ranked relative to one another based on job requisition information to generate a ranked set of the 100 jobs, and the ranked set of 100 jobs may be posted on a job requisition website for viewing by multiple candidates. In some embodiments, a job requisition-based machine learning model 130 operates on candidate information. This may be helpful, for example, to promote jobs to a specific candidate or subset of similar candidates. For example, a set of 100 job requisitions may be ranked relative to one another based on candidate information for a given candidate to generate a ranked set of the 100 jobs, and the ranked set of 100 jobs may be provided to the candidate or a subset of candidates determined to be similar to the candidate. In such an embodiment, the job requisition-based machine learning model 130 may interact with a candidate-based machine learning model 140. The job requisition-based machine learning model 130 may comprise the candidate-based machine learning model 140. For example, the job requisition-based machine learning model 130 may be an ensemble machine learning model of which the candidate-based machine learning model 140 is a part. In another example, the job requisition-based machine learning model 130 may communicate with the candidate-based machine learning model 140, either directly (e.g., before an output is reaches such as at a hidden layer, node, etc.) or by providing one or more input or output to the candidate-based machine learning model 140.

In some embodiments, the candidate-based machine learning model operates on job requisitions. For example, the candidate-based machine learning model 140 may operate on job requisitions, as previously described in reference to the job requisition-based machine learning model 130. The candidate-based machine learning model 140 may operate individually on job requisitions, such as when they are acquired by the candidate-based machine learning model 140, or may operate on a set of job requisitions. The input into the candidate-based machine learning model 140 may include one or more job requisitions and may comprise information about the one or more job requisitions or may include the one or more job requisitions tagged or otherwise identified with their corresponding information. In some embodiments, a candidate-based machine learning model operates on candidate information. For example, the input into the candidate-based machine learning model 140 may include information about a specific candidate, one or more candidates, a pool of candidates, a set of candidates, etc. The input into the candidate-based machine learning model 140 may, for example, be tagged or duplicated for substantially all of the candidates. The input into candidate-based machine learning model 140 may include candidate information such as candidate identity, candidate parameters, candidate experience, etc. For example, the candidate information may be pulled from a candidate database 150. In some embodiments, candidate information may be extracted from a candidate application, such as by using natural language processing to identify keywords or other candidate parameters, or may be obtained from the candidate database, including by using natural language processing or from candidate submitted information.

In some embodiments, the candidate-based machine learning model operates on the same of substantially the same information about each of the candidates. For example, the candidate-based machine learning model 140 may operate on the same or substantially the same information from each of the candidates. For example, the candidate-based machine learning model 140 may include or be in communication with a data standardizer or other data cleaning program or apparatus which may standardize the information associated with each of the candidates. In some embodiments, the candidate-based machine learning model operates on differing available information associated with each of the candidates. For example, the candidate-based machine learning model 140 may operate on different information, such as any information available, for each of the candidates. Candidate information may include, for example, information from a candidate application (e.g., the application 1a 108a and the application 1b 108b), from a candidate database (e.g., the candidate database 150), previous applications, etc.

In some embodiments, the candidate-based machine learning model operates on job information, such as job information operated on by the job requisition-based machine learning model 130. For example, the candidate-based machine learning model 140 may operate on job information comprising pub2now, number of open positions, number of applications submitted, location of job, employer or requisitioner of job, job start date, job duration, job specialty, other job parameters, etc., and on candidate information comprising pub2sub, current time, quantity of previous offers extended to a candidate, percentage of previous application which resulted in an offer extended to the candidate, years of experience, candidate specialty, etc. Further example parameters are described hereafter in reference to FIGS. 4A-4C. In some embodiments, a candidate-base machine learning model outputs rankings for one or more candidates. For example, the candidate-based machine learning model 140 may determine and output, based on the job requisitions, accompanying job information, and candidate information, an offer probability 142 or a ranking of the set of jobs or job requisitions for a specific candidate or for multiple candidates. The offer probability 142 may be, for example, individualized or provided for a batch of candidates. The offer probability 142 may, for example, include a ranking, which ranks the set of job requisitions for the specific candidate or the multiple candidates. In some embodiments, a candidate-based machine learning model determines a probability that a candidate will accept a job. For example, the output of the candidate-based machine learning model 140 may include an acceptance probability 144 or ranking of the set of jobs or job requisitions for a specific candidate or multiple candidates. The acceptance probability 144 may include, for example, a ranking, which ranks the set of job requisitions for the specific candidate or the multiple candidates based on which jobs, if offered, the candidate is most likely to accept. The acceptance probability 144 may instead or additionally be a probability or ranking of which jobs the candidate is most likely to be offered and to accept after being offered.

In some embodiments, the candidate-based machine learning model outputs a job requisition ranking. For example, the output of the candidate-based machine learning model 140 may include a job ranking, which may comprise an ordinal ranking of the jobs or job requisitions which were input into the candidate-based machine learning model 140. The candidate-based machine learning model 140 may, for example, output the offer probability 142, acceptance probability 144, or job ranking for all or substantially all of the jobs or job requisitions which where input or for a subset of the jobs or job requisitions which were input into the candidate-based machine learning model 140. For example, the candidate-based machine learning model 140 may determine that one or more job or job requisition is not a valid job requisition or has an offer probability or acceptance probability below a minimum threshold for a job offer being extended and exclude said job from the job ranking.

In some embodiments, the candidate-based machine learning model outputs the ranking to a candidate. For example, the output of the candidate-based machine learning model 140 may be delivered to one or more candidate interfaces, depicted as candidate X interface 160, in addition to or instead of the output of the job requisition-based machine learning model 130. The candidate interface may be, for example, an interface previously described. The output of the candidate-based machine learning model 140 may be a list of prioritized job requisitions 170, delivered via the candidate X interface 160. The list of prioritized job requisitions 170 may be presented in ranked order, may be presented with a likelihood of an offer being extended for at least a subset of the job requisitions, or may be displayed or provided in any appropriate manner. The candidate X interface 160 may, for example, deliver a list of prioritized job requisitions 170 which includes a list of job requisitions ranked for a generic candidate (e.g., a candidate agnostic ranking) and include candidate specific information. For example, the candidate X interface 160 may provide a newsletter listing new job requisitions based on the list of prioritized job requisitions 170 and also provide a “for you” section or other personalized information for at least a subset of the job requisitions on the list of prioritized job requisitions 170. In the context of a job candidate, the “for you” section may include a listing of job requisitions determined to be a sufficient match for the job candidate and include a note such as, “ . . . the following listing includes a set of job opening that have been determined to be a good match for you.”

In some embodiments, the candidate-based machine learning model outputs a ranking of the job requisitions for a pool of candidates. For example, the output of the candidate-based machine learning model 140 may be delivered to a candidate pool or candidate matching service, instead of or in addition to delivery to one or more candidate. The output of the candidate-based machine learning model 140 may optionally be delivered to a recruiting service or recruiter.

In some embodiments, the candidate-based machine learning model operates on applications. For example, the candidate-based machine learning model 140 may also operate based on applications submitted in response to the job requisitions, such as the applications 1a and 1b submitted in the application submission events 106a and 106b, respectively, based on candidates corresponding to applications submitted in response to the job requisitions, or a combination thereof. Candidate information may, for example, be appended to the applications 1a and 1b at the times of submission thereof. In some embodiments, a candidate-based machine learning model operates on an application that a candidate has submitted. For example, the candidate-based machine learning model 140 may provide after-submission information about a candidate application, such as likelihood of an offer being extended, etc. based on the application which was submitted. In some embodiments, a candidate-based machine learning model determines time-variable outputs. For example, the candidate-based machine learning model 140 may determine and update the likelihood of an offer being extended as a function of time (e.g., as the time from the application submission event increases). The likelihood of an offer being extended may decrease with time, such as as more applications are submitted in response to the job requisition. However, unexpected results may occur. For example, the likelihood of an offer being extended may increase with time, as the job requisition is closed or a decision is made, and then decrease with time and an offer is extended to another candidate or the position is filled or cancelled.

FIG. 2 is a diagram that depicts training of a job requisition-based machine learning model, in accordance with one or more embodiments. In some embodiments, the model is trained using a job requisition-based machine learning model training system 200. For example, in the illustrated embodiment, the system 200 includes a job requisition-based machine learning model trainer 260 that may be employed to train a job requisition-based machine learning model, such as the job requisition-based machine learning model 130 described with regard to at least FIG. 1. The job requisition-based machine learning model trainer 260 may be deployed in full or in part in a computing system, such as the computing system 900 (described in more detail with reference to at least FIG. 9) or the computing system 1000 (described in more detail with reference to at least FIG. 10).

In some embodiments, training of a job requisition-based machine learning model is based on a set of historical job requisitions. For example, the example system 200 for training the job requisition-based machine learning model 130 may operate upon information obtained from a job requisition database 210. The job requisition database 210 may comprise historical job requisition information, such as may be proprietary information of a job matching service. The job requisition database 210 may include information about previous job requisitions, including job requisition publishing events or times, applications submitted in response to job requisitions, outcomes corresponding to applications submitted in response to job requisitions. The example system 200 for training the job requisition-based machine learning model 130 may operate on another database or set of job requisitions, applications, outcomes, etc. which are not stored in a database or which are stored over multiple databases.

In some embodiments, a set of job requirements are acquired for use in training the job requisition-based machine learning model. For example, a set of job requisitions may be acquired from the job requisition database 210 for use in training the job requisition-based machine learning model 130. In the illustrated example, the set of job requisitions is depicted as including job 1 220a, job 2 220b, and job N 220c. However, the set of job requisitions may include more or fewer job requisitions. The set of job requisitions may include job requisitions from one or more employer, one or more location, one or more time period, etc. The set of job requisitions may include job requisitions from a rolling time window. For example, the set of job requisitions may include job requisitions from the last six months while omitting job requisitions older than six months. The set of job requisitions may be batched by specialty, employer, location, etc. or may be a set of job requisitions corresponding to one or more specialty, employer, location, etc.

In some embodiments, a job requisition-based machine learning model trainer trains the job requisition-based machine learning model. For example, the job requisition-based machine learning model trainer 260 may train, pre-train, or update training for the job requisition-based machine learning model 130. The job requisition-based machine learning model 130 may be one or more machine learning model, including an ensemble model. The job requisition database 210 may be organized or batch job requisitions into one or more training data sets for the machine learning models of the job requisition-based machine learning model 130. The set of job requisitions may include information about each of the job requisitions, including pub2now time (e.g., a current age of the job requisition or a pub2now or age of the job requisition at the time an application was submitted), a number of open positions, a number of applications submitted, other job specific features (e.g., employer, location, etc.), other parameters, etc. The set of job requisitions may include, for example, information acquired from the job requisition by natural language processing. The set of job requisitions may include, for example, values for the same information type or substantially the same information for each of the job requisitions. Alternatively, the set of job requisitions may include values for different information for different job requisitions. For example, the number of open positions may or may not be included in a job requisition. The set of job requisitions may include information contained in numerical values, as text strings, words, locations, currency values, etc.

In some embodiments, for each of the job requisitions included in the training data, an application is acquired. For example, for each of the job requisitions, one or more application submitted in response to the job requisition is acquired. In some embodiments, job requisitions which have no corresponding applications (e.g., for which no application was submitted or for which no application which was submitted is available in the job requisition database 210) may be included in the set of job requisitions. The job 1 220a is depicted as corresponding to an application 1a 230a and an application 1N 230b. The job 2 220b is depicted as corresponding to an applications 2a 230c and an application 230d. The job N 220c is depicted as corresponding to an application NN 230e and an application 230f The applications may be appended to the job requisitions or tagged or otherwise identified as corresponding to the job requisitions for which they were submitted. The applications may include information about each of the applications, including pub2sub time (e.g., an age of the job requisition at the time the application was submitted), information about whether an offer was extended in response to the application, information about whether an offer was extended and accepted in response to the application, other offer information, other candidate information, other parameters, etc. The applications may include information extracted from the application or otherwise processed. The applications may include the full text (and optionally formatting) of the application as submitted. The applications may include information extracted from the applications, such as by natural language processing. The applications may include values for the same information type or substantially the same information for each of the applications. Alternatively, the applications may include values for different information for different applications. For example, an application X may include a number of years of experience in a specific specialty, while an application Y may only include experience but not a specific number of years. The applications may include information contained in numerical values, as text strings, words, locations, currency values, etc.

In some embodiments, an outcome is determined for each application of the training data. For example, an outcome of the application may be acquired for each of the applications. In some embodiments, applications or job requisitions which have no outcomes (e.g., for which no application was submitted, for which no outcome is available, for which the job requisition is still open, etc.) may be included in the outcomes. The outcome of an application may be a binary outcome—e.g., a job offer was extended or a job offer was not extended. The outcome of an application be applied as a marker or tag to the application. For example, applications for which a job offer was extended may be marked as having a successful outcome. The outcome of an application may include additional information about the job offer, such as time from application being submitted to job offer being extended, salary of job offer, location of job offer and whether or not it corresponds to location of job requisition. The outcome of an application may include information about whether or not an offer was accepted. The outcome of an application may include additional information about the job acceptance, such as time from job offer being extended to time of job offer acceptance, salary negotiation information, etc. The outcome may include information extracted from a verbal or written job offer. The outcomes may include the full text (and optionally formatting) or full audio of the job offer as extended. The outcomes may include values for the same information type or substantially the same information for each of the applications. Alternatively, the outcomes may include values for different information for different applications. For example, an outcome Z may include information about acceptance of a job offer, while an outcome W may only indicate that a job offer was extended. The outcome may include information contained in numerical values, as yes-no values (e.g., Y/N), as text strings, words, currency values, etc.

In some embodiments, training data is generated to train the job requisition-based machine learning model. For example, the set of job requisitions, the applications, and the outcomes may be used to generate one or more sets of training data 250. The training data may comprise multiple entries, depicted as entries 252a-252f, corresponding to job requisitions, applications submitted in response to the job requisitions, and outcomes for the applications submitted in response to the job requisitions. The entries 252a-252f may comprise one or more applications per job requisitions and one or more outcome per application. The set of training data 250 may be divided include a test set, a validation set, etc. used in training, testing, or validation of the job requisition-based machine learning model 130. The set of training data 250 may be updated as the job requisition database 210 acquires more information, including additional job requisitions, additional applications, additional outcomes. The set of training data 250 may be updated based on the model's behavior. The set of training data 250 may be divided into batches used to training one or more models of a set of machine learning models or of an ensemble of machine learning models. The set of training data 250 may be used to retrain, update training, or train a partially trained machine learning model.

In some embodiments, the training data is processed. For example, the set of training data 250 may be cleaned or filtered. The set of training data 250 may be an unbalanced training set, where more applications do not result in an offer being extended than do result in an offer being extended. The set of training data 250 may be adjusted to be more balanced, or other methods suitable for training a machine learning model with an unbalanced set of training data 250 may be applied in one or more model of the job requisition-based machine learning model 130.

In some embodiments, the job requisition-based machine learning model is trained based on the training data. For example, the job requisition-based machine learning model trainer 260 may train the job requisition-based machine learning model 130 based on the set of training data 250. The job requisition-based machine learning model trainer 260 may train one or more machine learning models of the job requisition-based machine learning model 130 at a time. The job requisition-based machine learning model trainer 260 may comprise multiple trainers or training events, including sequential training, iterative training, updated training, etc. The job requisition-based machine learning model trainer 260 may operate to train the job requisition-based machine learning model 130 at regular intervals or on updated sets of training data 250 at regular intervals. The job requisition-based machine learning model trainer 260 may train the job requisition-based machine learning model 130 to output a probability, score, or ranking of a likelihood of a job offer being extended based on a job requisition and parameters of that job requisition. The parameters of the job requisition used to rank the job requisition may vary between models of the job requisition-based machine learning model 130. The job requisition-based machine learning model trainer 260 may train one or more machine learning model and may optimize or train the machine learning models based on a loss or optimization function.

FIG. 3 is a diagram that depicts training of a candidate-based machine learning model, in accordance with one or more embodiments. In some embodiments, the candidate-based machine learning model is trained using a candidate-based machine learning model training system 300. For example, in the illustrated embodiment, the system 300 includes a candidate-based machine learning model trainer 380 that may be employed to train a candidate-based machine learning model, such as the candidate-based machine learning model 140 described with regard to at least FIG. 1. The candidate-based machine learning model trainer 380 may be deployed in full or in part in a computing system, such as the computing system 900 (described in more detail with reference to at least FIG. 9) or the computing system 1000 (described in more detail with reference to at least FIG. 10).

In some embodiments, the candidate-based machine learning model is trained based on a set of job requisitions. For example, the example system 300 for training the candidate-based machine learning model 140 may operate upon information obtained from a job requisition database 210, as previously described in reference to FIG. 2. A set of job requisitions may be acquired from the job requisition database 210. The set of job requisitions is depicted as including jobs 320a, 320b. The set of job requisitions may be any appropriate job requisitions, as previously described in reference to FIG. 2.

In some embodiments, the candidate-based machine learning model trainer trains the candidate-based machine learning model. For example, the candidate-based machine learning model trainer 380 may train, pre-train, or update training for the candidate-based machine learning model 140. The candidate-based machine learning model 140 may be one or more machine learning models, including an ensemble model, and may be part of, in communication with, or additional to the job requisition-based machine learning model 130. The job requisition database 210 may be organized or batch job requisitions into one or more training data sets for the machine learning models of the candidate-based machine learning model 140. The set of job requisitions may include information about each of the job requisitions, including pub2now time (e.g., a current age of the job requisition or a pub2now or age of the job requisition at the time an application was submitted), a number of open positions, a number of applications submitted, other job specific features (e.g., employer, location, etc.), other parameters, etc. Further example information is described hereafter in reference to FIGS. 4A-4C. The set of job requisitions may include, for example, information acquired from the job requisition by natural language processing. The set of job requisitions may include, for example, values for the same information type or substantially the same information for each of the job requisitions. Alternatively, the set of job requisitions may include, for example, values for different information for different job requisitions. For example, the number of open positions may or may not be included in a job requisition. The set of job requisitions may include information contained in numerical values, as text strings, words, locations, currency values, etc.

In some embodiments, the candidate-based machine learning model trainer acquires applications corresponding to job requisitions. For example, for each of the job requisitions, one or more application submitted in response to the job requisition is acquired, as previously described in reference to FIG. 2. In some embodiments, job requisitions which have no corresponding applications (e.g., for which no application was submitted or for which no application which was submitted is available in the job requisition database 210) may be included in the set of job requisitions. Applications 330a-330c are depicted for ease of description. The applications may be appended to the job requisitions or tagged or otherwise identified as corresponding to the job requisitions for which they were submitted. The applications may include information about each of the applications, including pub2sub time (e.g., an age of the job requisition at the time the application was submitted), information about whether an offer was extended in response to the application, information about whether an offer was extended and accepted in response to the application, other offer information, other candidate information, other parameters, etc. The applications may include information extracted from the application or otherwise processed. The applications may include the full text (and optionally formatting) of the application as submitted. The applications may include information extracted from the applications, such as by natural language processing. The applications may include values for the same information type or substantially the same information for each of the applications. Alternatively, the applications may include values for different information for different applications.

In some embodiments, the candidate-based machine learning model trainer acquires candidate information. For example, for each of the applications, candidate information is acquired. Candidate information for a candidate M 340a is depicted, corresponding to the candidate of the application 330a. Candidate information for a candidate L 340b is depicted, corresponding to the candidate of the application 330c. The candidate information may, for example, be acquired from the application itself, such as by using natural language processing data extraction 360. The candidate information may also or instead be acquired from a candidate database 350. The candidate database 350 may comprise candidate information, such as may be proprietary information of a job matching service or was previously provided by the candidate. The candidate database 350 may include information about previous job requisitions to which the candidate applied, previous offers which were extended to the candidate, previous offers which were extended to the candidate which the candidate accepted, etc. The job requisitions which the candidate has previously applied to may include information about job requisition publishing events or times, applications submitted in response to job requisitions, outcomes corresponding to applications submitted in response to job requisitions. The example system 300 for training the candidate-based machine learning model 140 may operate on another database or candidate information source, applications, outcomes, etc. which are not stored in a database or which are stored over multiple databases.

In some embodiments, the candidate information includes information about the candidate extracted from applications. For example, the candidate information may include experience of the candidate (amount of previous experience, level of previous experience, certifications, etc.). The candidate information may include a historical offer rate, a number of historical offers, number of job requisitions for which a candidate has submitted an application, specialization, location, distance from a candidate location to the job requisition location, historical employment by the candidate at the same or a different facility operated by the employer, number of offers the candidate has received in a time window (for example, in the last two weeks), amount of time the candidate has been actively viewing job requisitions, amount of time the candidate has been inactive or not actively viewing job requisitions, candidate's current employment status, candidate's current employment location, number of submitted applications, etc.

In some embodiments, the candidate-based machine learning model trainer acquires information about outcomes. For example, for each of the applications, an outcome of the application is acquired, as previously described in reference to FIG. 2. In some embodiments, applications or job requisitions which have no outcomes (e.g., for which no application was submitted, for which no outcome is available, for which the job requisition is still open, etc.) may be included in the outcomes. The outcome of an application may be a binary outcome—e.g., a job offer was extended or a job offer was not extended. The outcome of an application be applied as a marker or tag to the application. For example, applications for which a job offer was extended may be marked as having a successful outcome. The outcome of an application may include additional information about the job offer, such as time from application being submitted to job offer being extended, salary of job offer, location of job offer and whether or not it corresponds to location of job requisition. The outcome of an application may include information about whether or not an offer was accepted. The outcome of an application may include additional information about the job acceptance, such as time from job offer being extended to time of job offer acceptance, salary negotiation information, etc. The outcome may include information extracted from a verbal or written job offer. The outcomes may include the full text (and optionally formatting) or full audio of the job offer as extended. The outcomes may include values for the same information type or substantially the same information for each of the applications. Alternatively, the outcomes may include values for different information for different applications. The outcome may include information contained in numerical values, as yes-no values (e.g., Y/N), as text strings, words, currency values, etc.

In some embodiments, job requisitions, applications, and outcomes are used to generate training data. For example, the set of job requisitions, the applications, and the outcomes may be used to generate one or more sets of training data 370. The training data may comprise multiple entries, depicted as entries 372a-37b, corresponding to job requisitions, applications submitted in response to the job requisitions, and outcomes for the applications submitted in response to the job requisitions. The entries 372a-37b may comprise one or more applications per job requisitions with each application corresponding to a candidate and one or more outcome per application. The set of training data 370 may include one or more application per candidate, including applications to the same or similar job requisitions or applications to different job requisitions. The set of training data 370 may be divided include a test set, a validation set, etc. used in training, testing, or validation of the candidate-based machine learning model 140. The set of training data 370 may be updated as the job requisition database 210 or candidate database 350 acquires more information, including additional job requisitions, additional applications, additional outcomes. The set of training data 370 may be updated based on the model's behavior. The set of training data 370 may be divided into batches used to training one or more models of a set of machine learning models or of an ensemble of machine learning models. The set of training data 370 may be used to retrain, update training, or train a partially trained machine learning model. The set of training data 370 may be used to train a model or set of models (which may be an ensemble of machine learning models) for each candidate or group of candidates. For example, candidates may be grouped by specialty or location and a model may be trained for each set of candidates based on their preselected characteristics.

In some embodiments, the training data is cleaned. For example, the set of training data 370 may be cleaned or filtered. For example, candidates who submitted incomplete applications may be excluded. The set of training data 370 may be an unbalanced training set, where more applications do not result in an offer being extended than do result in an offer being extended. The set of training data 370 may also be unbalanced in that a subset of candidates may receive the bulk or a significant portion of the job offers extended, while another subset of candidates receives no or few job offers extended. The set of training data 370 may be adjusted to be more balanced, or other methods suitable for training a machine learning model with an unbalanced set of training data 370 may be applied in one or more model of the candidate-based machine learning model 140. In some embodiments, the candidate-based machine learning model 140 may identify candidates who receive relatively fewer offers extended based on applications and provide such candidates resume or skill building offers or training.

In some embodiments, the candidate-based machine learning model trainer trains the candidate-based machine learning model. For example, the candidate-based machine learning model trainer 380 may train the candidate-based machine learning model 140 based on the set of training data 370. The candidate-based machine learning model trainer 380 may train one or more machine learning model of the candidate-based machine learning model 140 at a time. The candidate-based machine learning model trainer 380 may comprise multiple trainers or training events, including sequential training, iterative training, updated training, etc. The candidate-based machine learning model trainer 380 may operate to train the candidate-based machine learning model 140 at regular intervals or on updated sets of training data 370 at regular intervals. The candidate-based machine learning model trainer 380 may also train the candidate-based machine learning model 140 based on a push or pull request from a candidate or based on a candidate's job search. For example, the candidate-based machine learning model trainer 380 may be updated or retrained if a candidate does not receive an offer which the candidate-based machine learning model 140 predicted that the candidate would receive.

In some embodiments, the candidate-based machine learning model is trained to output a probability based on a job requisition and candidate pair. For example, the candidate-based machine learning model trainer 380 may train the candidate-based machine learning model 140 to output a probability, score, or ranking of a likelihood of a job offer being extended based on a job requisition, parameters of that job requisition, and candidate parameters. The parameters of the job requisition used to rank the job requisition may vary between models of the candidate-based machine learning model 140. The candidate-based machine learning model trainer 380 may train one or more machine learning model and may optimize or train the machine learning models based on a loss or optimization function.

In some embodiments, the candidate-based machine learning model is trained to output the ranking of candidates. For example, the output of the candidate-based machine learning model 140 may be delivered to one or more employer and/or candidate matching service, such as via an employer-side interface. The employer-side interface may be, for example, an interface previously described. The output of the candidate-based machine learning model 140 may be a list of prioritized candidates (e.g., candidate applications), delivered via the employer-side interface. The list of prioritized candidates may be presented in ranked order, may be presented with a likelihood of an offer being accepted for at least a subset of the candidates, or may be displayed or provided in any appropriate manner. The employer-side interface may, for example, deliver a list of prioritized candidates which include candidates who have submitted an application for a specific position, who have previously submitted an application for a position at the same employer, who have previously submitted an application and/or information to a matching service, who have previously worked for the employer, etc. For example, employer-side interface may provide a newsletter listing additional candidates based on the list of prioritized candidates and also provide a “top candidates” section or other personalized information for at least a subset of the candidates on the list of prioritized candidates. In the context of an employer, the “top candidates” section may include a listing of candidates determined to be a sufficient match for the job requisition and include a note such as, “ . . . the following listing includes a set of candidates that have been determined to be a good match for you.”

FIGS. 4A-4C are tables 400, 410, 420 that illustrate example parameters for at least one of a job requisition-based machine learning model, a candidate-based machine learning model, or a combination thereof. Table 400 of FIG. 4A lists illustrative facility parameters, including facility_app2sub_rate, facility_app2offer_rate, etc. together with a brief description of each parameter. Table 410 of FIG. 4B lists illustrative job requisition parameters, including days_til_start_date, job_view2app_ratio, etc., together with a brief description of each parameter. Table 420 of FIG. 4C lists exemplary candidate parameters, including num_active_apps, on assignment, etc., together with a brief description of each parameter. The various parameters are provided as examples of job information, candidate information, etc. which may be acquired and/or operated on by the job requisition-based machine learning model, the candidate-based machine learning model, or both.

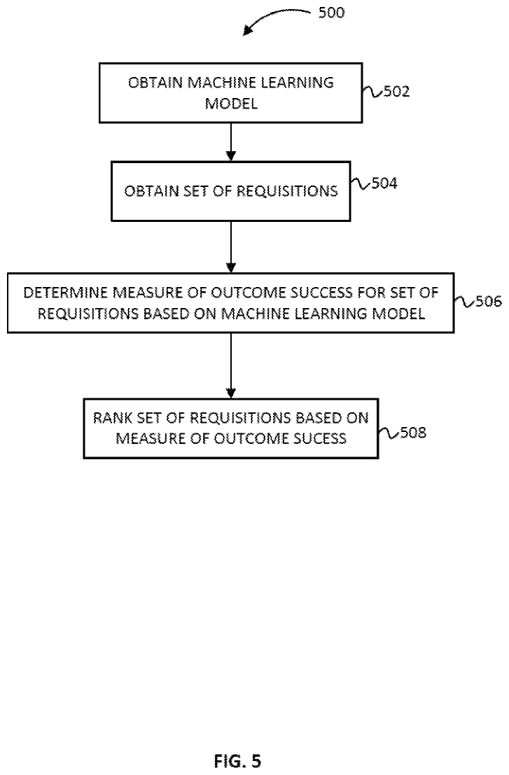

FIG. 5 is a diagram that illustrates an exemplary method 500 for ranking of requisitions using a machine learning model, according to one or more embodiments. Example operations of the method are described in detail below. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting. In some embodiments, one or more portions of method 500 may be implemented (e.g., by simulation, modeling, etc.) in one or more processing devices (e.g., one or more processors of the computing devices described here). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500, for example. For illustrative purposes, optional operations are depicted with dashed lines. However, operations which are shown with unbroken lines may also be optional or may be omitted.

In some embodiments, a machine learning model is obtained (block 502). The machine learning model may be an ensemble of machine learning models. The machine learning model may be trained or at least partially untrained. The machine learning model may be any appropriate type of machine learning model, including a decision tree model, a random forest model, a gradient boosted decision tree, a neural network, a classification model, a regression model, a supervised learning model, etc. The machine learning model may contain any appropriate arrangement of layers, inputs, outputs, weightings, etc.

In some embodiments, a set of requisitions is obtained (block 504). The requisitions may be job requisitions. The requisitions may be short term requisitions (such as gig work) or long-term employment requisitions. The requisitions may also be other supply requisitions, such as volunteer spots, training spots, or other solicitations for employees or goods.

In some embodiments, a measure of outcome success for the set of requisitions is determined based on the machine learning model (block 506). The measure of outcome success may be the likelihood of a job offer being extended, an acceptance of a proposal, etc. The measure of outcome success may be expressed as a score (for example, a numerical value between 0 and 1 or between 0 and 100), a value level (for example, good, medium, bad), a probability, etc. The measure of outcome success may include a confidence interval or other measure of the quality of the determination. The measure of outcome success may be a range. The measure of outcome success may include multiple measures of outcome success, such as from different machine learning models of an ensemble of machine learning models, or may average (including using a weighted average) multiple measures of outcome success to generate a total measure of outcome success. The measure of outcome success may be different for each of the set of requisitions or may be determined for multiple requisitions together.

In some embodiments, the set of requisitions is ranked based on the measure of outcome success (block 508). The set of requisitions may be ordinally ranked from most likelihood of success to least. The set of requisitions may also be ranked for all requisitions with a likelihood of success greater than a minimum threshold. The set of requisitions may be batched into requisitions with high likelihood of success, medium likelihood of success, etc.

As described above, method 500 (and/or the other methods and systems described herein) may provide a generic framework for ranking of requisitions using a machine learning model.

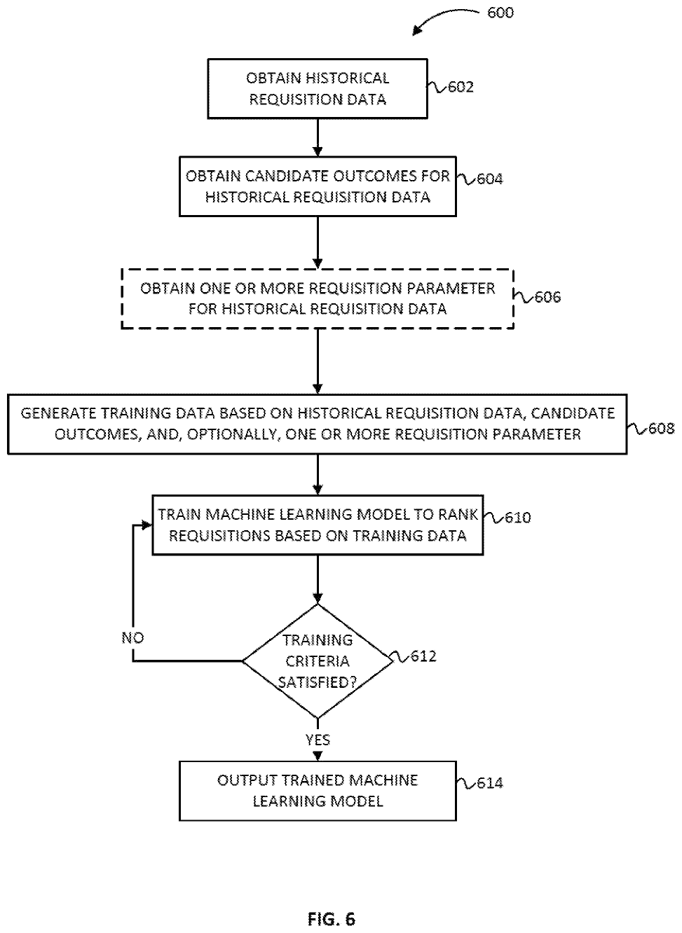

FIG. 6 is a diagram that illustrates an exemplary method 600 for training a machine learning model to rank requisitions, according to one or more embodiments. Example operations of the method are described in detail below. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting. In some embodiments, one or more portions of method 600 may be implemented (e.g., by simulation, modeling, etc.) in one or more processing devices (e.g., one or more processors of the computing devices described here). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600, for example. For illustrative purposes, optional operations are depicted with dashed lines. However, operations which are shown with unbroken lines may also be optional or may be omitted.

In some embodiments, historical requisition data is obtained (block 602). The historical requisition data may include job requisitions, job requisition history, etc. The historical requisition data may be obtained from a database, reconstructed based on submitted applications, obtained from a candidate-requisition matching service, etc. The historical requisition data may include information about applications submitted in response to requisitions. The application information may include application submission timing (e.g., pub2now, pub2sub times), number of applications submitted, order of applications submitted, etc.

In some embodiments, candidate outcomes are obtained for the historical requisition data (block 604). The candidate outcomes may include whether a job offer was extended, timing of a job offer extension, whether a job offer was extended and accepted, job offer salary, job offer location, etc. The candidate outcomes may include some information also included in the historical requisition data, such as redundant information. The candidate outcomes may be part of the historical requisitions data.

In some embodiments, one or more requisition parameter is obtained for the historical requisition data (block 606). The requisition parameters may include employer (e.g., hospital system), employer location (for example, which branch of the employer's hospital, state, etc.), employer's contractual relationship to one or more matching service, specialization of requisition, compensation rate of requisition, number of requisition openings, etc. The one or more requisition parameter may be determined based on the requisition, based on applications submitted in response to the requisition, inferred from the requisition or other information, etc.

In some embodiments, training data is generated based on the historical requisition data, candidate outcomes, and, optionally, one or more requisition parameter (block 608). The training data may be generated in any appropriate manner, such as that described in relation to FIG. 2.

In some embodiments, the machine learning model is trained to rank requisitions based on the training data (block 610). The machine learning model may be trained in any appropriate manner.

In some embodiments, it is determined if training criteria is satisfied (block 612). The training criteria may be a number of iterations of training, training on substantially all of a set of training data, an accuracy for a test set, an accuracy for a validation set, etc. The training criteria may be any appropriate training criteria. If the training criteria is not satisfied, the model is further trained (e.g., at block 610). The model may be updated or further trained, or a new model may be trained.

In some embodiments, if the training criteria is satisfied, the trained machine learning model is output (block 614). The trained machine learning model may optionally receive further training if a new training data set is generated or acquired. The trained machine learning model may be output to a memory for use by a processor.

As described above, method 600 (and/or the other methods and systems described herein) may provide a generic framework for training a machine learning model to rank requisitions.

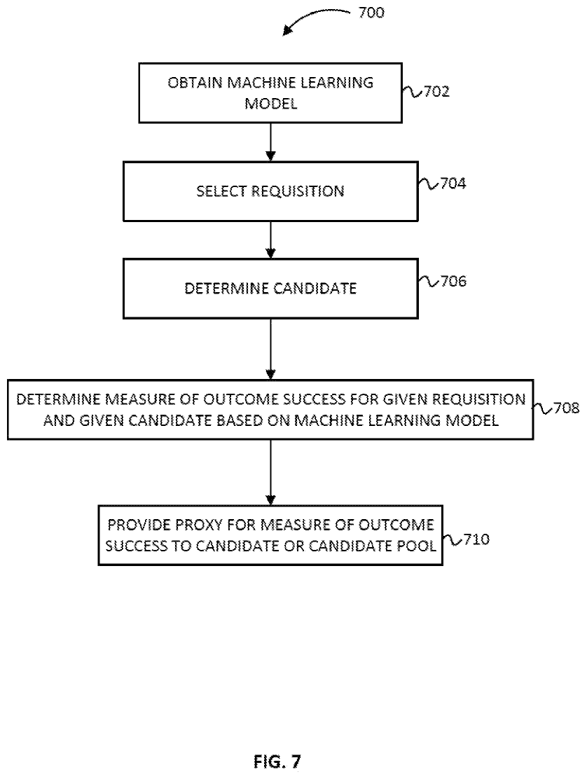

FIG. 7 is a diagram that illustrates an exemplary method 700 for determining a measure of outcome success for a candidate for a requisition, according to one or more embodiments. Example operations of the method are described in detail below. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting. In some embodiments, one or more portions of method 700 may be implemented (e.g., by simulation, modeling, etc.) in one or more processing devices (e.g., one or more processors of the computing devices described here). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700, for example. For illustrative purposes, optional operations are depicted with dashed lines. However, operations which are shown with unbroken lines may also be optional or may be omitted.

In some embodiments, a machine learning model is obtained (block 702). The machine learning model may be an ensemble of machine learning models. The machine learning model may be trained or at least partially untrained. The machine learning model may be any appropriate type of machine learning model, including a decision tree model, a random forest model, a gradient boosted decision tree, a neural network, a classification model, a regression model, a supervised learning model, etc. The machine learning model may contain any appropriate arrangement of layers, inputs, outputs, weightings, etc.

In some embodiments, a requisition is selected (block 704). The requisition may be selected from a set of requisitions. The requisition may be a job requisition. The requisitions may a be short term requisition (such as gig work) or long-term employment requisitions. The requisition may also be another supply requisition, such as a volunteer spot, a training spots, or other solicitations for an employee or good.

In some embodiments, a candidate is selected (block 706). The candidate may be selected from a set of candidates. The candidate may be a job applicant or a potential job applicant. The candidate may select the requisition, such that the machine learning model operates at the behest of the candidate on a specific requisition or set of requisitions. The candidate may be a nurse. The candidate may be a job seeker, or an entity seeking to provide employees or goods in response to a requisition.

In some embodiments, a measure of outcome success for the given requisitions and given candidate is determined based on the machine learning model (block 708). The measure of outcome success may be the likelihood of a job offer being extended, an acceptance of a proposal, etc. The measure of outcome success may be expressed as a score (for example, a numerical value between 0 and 1 or between 0 and 100), a value level (for example, good, medium, bad), a probability, etc. The measure of outcome success may include a confidence interval or other measure of the quality of the determination. The measure of outcome success may be a range. The measure of outcome success may include multiple measures of outcome success, such as from different machine learning models of an ensemble of machine learning models, or may average (including using a weighted average) multiple measures of outcome success to generate a total measure of outcome success. The measure of outcome success may be different for each of the set of requisitions or may be determined for multiple requisitions together.

In some embodiments, a proxy for the measure of outcome success is provided to the candidate or candidate pool (block 710). A candidate pool may include the candidate. The candidate pool may be operated by a candidate-requisition matching service. The proxy for the measure of outcome success may be the measure of outcome success (e.g., a probability of success, a likelihood of an offer being extended, etc.). The proxy for the measure of outcome success may also be a visual or interface-based promotion of the highest ranked requisitions by measure of outcome success. For example, an email with jobs for which the candidate has a high measure of outcome success may be generated. For example, for a candidate pool a ranking of candidates for a requisition may be generated, a ranking of candidate-requisition pairs may be generated, the candidate with the best measure of outcome success may be identified per requisition, etc.

As described above, method 700 (and/or the other methods and systems described herein) may provide a generic framework for determining a measure of outcome success for a candidate for a requisition.

In some embodiments, matching of job candidates with job openings is used as a basis for employment of candidates. For example, a job candidate may be provided with a ranked listing of “matching” job openings (e.g., determined as described herein) that lists one or more jobs determined to be a good match for the job candidate. As a result, the job candidate may submit an application for a job opening on the list, be hired by the employer for the job opening, and ultimately work for the employer to perform the job. For example, a candidate for a short-term nursing position may receive a ranked listing of “matching” short-term nursing positions determined to be a good match for the candidate. The candidate may, in turn, select a short-term nursing job from the listing and submit an application for the job opening to an associated medical facility. The medical facility may, in turn, hire the candidate for the short-term nursing job, and the candidate (now hired) may work at the medical facility to complete the short-term nursing position. In the context of an employer, an employer may be provided with a ranked listing of “matching” job candidates (e.g., determined as described herein) that lists one or more job candidates determined to be a good match for job openings held by the employer. As a result, the employer (or a matching system) may select a job candidate from the listing and solicit the selected job candidate to submit an application for the job opening. The job candidate may, in turn, submit an application for the job opening, and the employer may hire the job candidate for the job opening and ultimately employ the job candidate to perform the job. For example, a medical facility may be provided with a ranked listing of “matching” job candidates that lists one or more job candidates determined to be a good match for short-term nursing openings held by the employer (e.g., determined as described herein). As a result, the medical facility (or a matching system) may select a job candidate from the listing and solicit the job candidate to submit an application for the short-term nursing job opening. The candidate may, in turn, submit an application for the short-term nursing job opening, and the medical facility may hire job candidate and ultimately employ the job candidate to perform the short-term nursing job at the medical facility.

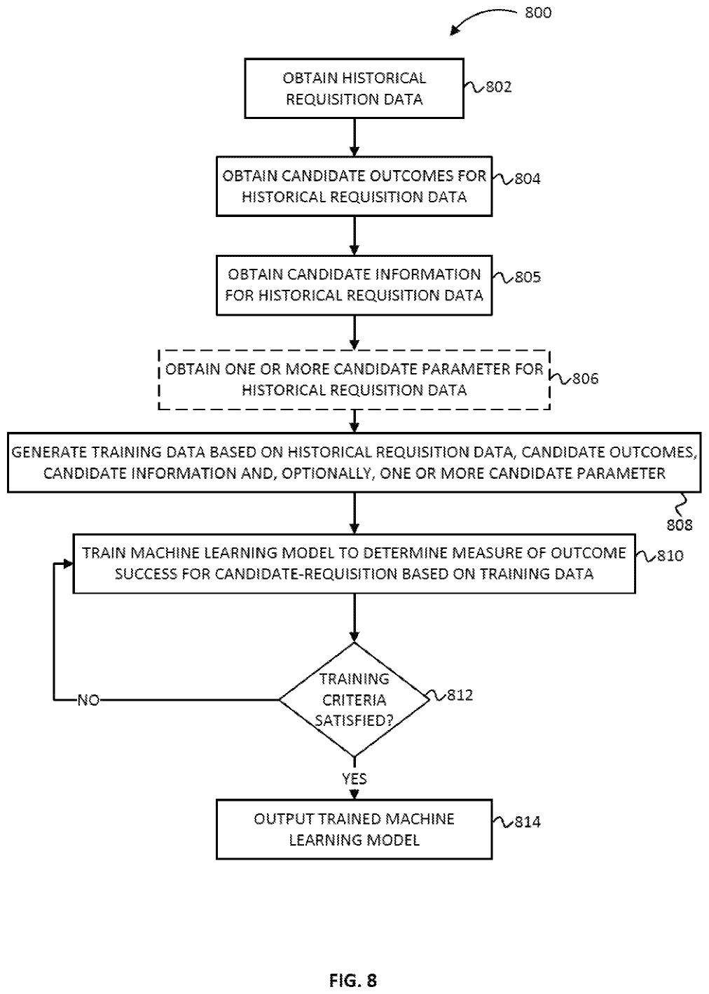

FIG. 8 is a diagram illustrates an exemplary method 800 for training a machine learning model to determine a measure of outcome success for a candidate-requisition instance, according to one or more embodiments. Example operations of the method are described in detail below. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting. In some embodiments, one or more portions of method 800 may be implemented (e.g., by simulation, modeling, etc.) in one or more processing devices (e.g., one or more processors of the computing devices described here). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800, for example. For illustrative purposes, optional operations are depicted with dashed lines. However, operations which are shown with unbroken lines may also be optional or may be omitted.

In some embodiments, historical requisition data is obtained (block 802). The historical requisition data may include job requisitions, job requisition history, etc. The historical requisition data may be obtained from a database, reconstructed based on submitted applications, obtained from a candidate-requisition matching service, etc. The historical requisition data may include information about applications submitted in response to requisitions. The application information may include application submission timing (e.g., pub2now, pub2sub times), number of applications submitted, order of applications submitted, etc.

In some embodiments, candidate outcomes are obtained for the historical requisition data (block 804). The candidate outcomes may include whether a job offer was extended, timing of a job offer extension, whether a job offer was extended and accepted, job offer salary, job offer location, etc. The candidate outcomes may include some information also included in the historical requisition data, such as redundant information. The candidate outcomes may be part of the historical requisitions data.

In some embodiments, candidate information is obtained for the historical requisition data (block 805). The candidate data may identify the candidate. The candidate data may include biographical or historical information, including information about the candidates' previous applications or job offers. The candidate outcomes may be included in the candidate information. The candidate information may also be part of the historical requisitions data. The candidate information may be extracted from one or more application or from a candidate database.

In some embodiments, one or more candidate parameter is obtained for the historical requisition data (block 806). The candidate parameters may include candidate specialty, candidate experience level, candidate's previous employment status, candidate location, percentage of applications for which candidate was extended a job offer, etc. The one or more candidate parameter may be determined based on the requisition, based on applications submitted in response to the requisition, inferred from the requisition or other information, etc.

In some embodiments, training data is generated based on the historical requisition data, candidate outcomes, and, optionally, one or more requisition parameter (block 808). The training data may be generated in any appropriate manner, such as that described in relation to FIG. 3.

In some embodiments, the machine learning model is trained to rank requisitions based on the training data (block 810). The machine learning model may be trained in any appropriate manner.

In some embodiments, it is determined if training criteria is satisfied (block 812). The training criteria may be a number of iterations of training, training on substantially all of a set of training data, an accuracy for a test set, an accuracy for a validation set, etc. The training criteria may be any appropriate training criteria. If the training criteria is not satisfied, the model is trained (e.g., at the block 810). The model may be updated or further trained, or a new model may be trained.

In some embodiments, if the training criteria is satisfied, the trained machine learning model is output (block 814). The trained machine learning model may optionally receive further training if a new training data set is generated or acquired. The trained machine learning model may be output to a memory for use by a processor.

As described above, method 800 (and/or the other methods and systems described herein) is configured to provide a generic framework determining for training a machine learning model to determine a measure of outcome success for a candidate-requisition instance.

FIG. 9 is a diagram that illustrates an exemplary method 900 for ranking of applications using a machine learning model, according to one or more embodiments. Example operations of the method are described in detail below. The operations of method 900 presented below are intended to be illustrative. In some embodiments, method 900 may be accomplished with one or more additional operations not described, and/or without one or more of the operations discussed. Additionally, the order in which the operations of method 900 are illustrated in FIG. 9 and described below is not intended to be limiting. In some embodiments, one or more portions of method 900 may be implemented (e.g., by simulation, modeling, etc.) in one or more processing devices (e.g., one or more processors of the computing devices described here). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900, for example. For illustrative purposes, optional operations are depicted with dashed lines. However, operations which are shown with unbroken lines may also be optional or may be omitted.

In some embodiments, a machine learning model is obtained (block 902). The machine learning model may be an ensemble of machine learning models. The machine learning model may be trained or at least partially untrained. The machine learning model may be any appropriate type of machine learning model, including a decision tree model, a random forest model, a gradient boosted decision tree, a neural network, a classification model, a regression model, a supervised learning model, etc. The machine learning model may contain any appropriate arrangement of layers, inputs, outputs, weightings, etc.

In some embodiments, a set of applications is obtained (block 904). The applications may be job applications. The applications may each correspond to a given candidate. The applications may each correspond to a given requisition, which may be a job requisition. The requisitions may be short term requisitions (such as gig work) or long-term employment requisitions. The requisitions may also be other supply requisitions, such as volunteer spots, training spots, or other solicitations for employees or goods. In some embodiment, the applications may include open-ended applications, which may correspond to multiple requisitions (e.g., be intended to be applications to two or more requisitions). In some embodiments, the applications may include group applications, which may correspond to multiple candidates (e.g., be an application for a team of candidates, such as a team of nurses, in response to one or more requisition).

In some embodiments, a measure of outcome success for the set of applications is determined based on the machine learning model (block 906). The measure of outcome success may be the likelihood of a job offer being extended, an acceptance of a proposal, etc. The measure of outcome success may be expressed as a score (for example, a numerical value between 0 and 1 or between 0 and 100), a value level (for example, good, medium, bad), a probability, etc. The measure of outcome success may include a confidence interval or other measure of the quality of the determination. The measure of outcome success may be a range. The measure of outcome success may include multiple measures of outcome success, such as from different machine learning models of an ensemble of machine learning models, or may average (including using a weighted average) multiple measures of outcome success to generate a total measure of outcome success. The measure of outcome success may be different for each of the set of requisitions or may be determined for multiple requisitions together.

In some embodiments, the set of applications is ranked based on the measure of outcome success (block 908). The set of applications may be ordinally ranked from most likelihood of success to least. The set of applications may also be ranked for all applications with a likelihood of success greater than a minimum threshold. The set of applications may be batched into requisitions with high likelihood of success, medium likelihood of success, etc. The set of applications may be ranked overall, substantially all, or some of the requisitions corresponding to the set of applications. The set of applications may be ranked according to one or more given requisitions, for all, substantially all, or some of the requisitions corresponding to the set of applications. For example, a subset of applications which correspond to a requisition A may be ranked (e.g., ranked as application A1, application A2, etc.) and a subset of applications which correspond to a requisition B may be ranked (e.g., ranked as application B1, application B2, etc.), where the subset of applications for requisition A and the subset of applications for requisition B may be ranked independently (e.g., in separate rankings) or ranked with respect to one another (e.g., ranked as application A1, application B1, application B2, application A2, etc.). The set of applications may be ranked overall, substantially all, or some of the candidates corresponding to the set of applications. The set of applications may be ranked per candidate or group of candidates corresponding to the set of applications. For example, a subset of applications which correspond to a candidate α may be ranked (e.g., ranked as application α1, application α2, etc.) and a subset of applications which correspond to a candidate β may be ranked (e.g., ranked as application β1, application β2, etc.). The subset of applications for candidate α and the subset of applications for candidate β may be ranked independently, or may be ranked with respect to one another (e.g., ranked as application β1, application α1, application α2, application β2, etc.).

In some embodiments, the set of applications is processed based on the ranking (block 910). The set of applications may be processed based on the ranking based on the measure of outcome success. The set of applications may be processed based on the measure of outcome success. The set of applications may be processed in batches. The set of applications may be filtered, for example, based on completeness, before being processed. In some embodiments, the set of applications may be filtered before a measure of outcome success is determined. The set of applications may be processed manually or automatically. The set of applications may be processed by being submitted to one or more requisition supplier in response to a requisition.

As described above, method 900 (and/or the other methods and systems described herein) may provide a generic framework for ranking of applications using a machine learning model.

FIG. 10 is a diagram that illustrates an example computing system 1000 that implements a machine learning model, in accordance with one or more embodiments. The computing system 1000 may include a machine learning (ML) system 1010, a user interface 1030, a firewall 1060, a requisition database 1040 and, optionally, a candidate database 1050. The ML system 1010 may include a communication subsystem 1012, and a machine learning (ML) subsystem 1014. The communication subsystem 1012 may retrieve one or more datasets from the requisition database 1040 or the candidate database 1050 for use in training or performing inference via the ML subsystem 1014 (e.g., using one or more machine-learning models as previously described). The requisition database 1040 and the candidate database 1050 may be a unified database or comprised of multiple data storage units.

The user interface 1030 may be a variety of different types of computing devices, including, but not limited to (which is not to suggest that other lists are limiting), a laptop computer, a tablet computer, a hand-held computer, smartphone, other computer equipment (e.g., a server or virtual server), including “smart,” wireless, wearable, Internet of Things device, or mobile devices. The user interface 1030 may be any device used by a healthcare professional (e.g., a mobile phone, a desktop computer used by healthcare professionals at a medical facility, etc.). The user interface 1030 may send commands to the ML system 1010 (e.g., to train a machine-learning model, perform inference, etc.). Although only one user interface 1030 is shown, the computing system 1000 may include any number of interfaces, for example, provided on one or more client devices.

The user interface 1030 may be separated from ML system 1010 by a firewall 1060, which may be a one-way firewall 1060. The user interface 1030 may be blocked from accessing private or proprietary data of the requisition database 1040 or candidate database 1050. Other non-private or personal data may be visible to the user of the user interface 1030.

The ML system 1010 may include one or more computing devices described above and may include any type of mobile terminal, fixed terminal, or other device. For example, the ML system 1010 may be implemented as a cloud computing system and may feature one or more component devices. Users may, for example, utilize one or more other devices to interact with devices, one or more servers, or other components of computing system 1000. In some embodiments, operations described herein as being performed by particular components of the computing system 1000, may be performed by other components of the computing system 1000 (which is not to suggest that other features are not also amenable to variation). As an example, while one or more operations are described herein as being performed by components of the ML system 1010, those operations may be performed by components of the user interface 1030, requisition database 1040 or candidate database 1050. In some embodiments, the various computers and systems described herein may include one or more computing devices that are programmed to perform the described functions. In some embodiments, multiple users may interact with computing system 1000. For example, a first user and a second user may interact with the ML system 1010 using two different user devices.

One or more components of the ML system 1010, user interface 1030, requisition database 1040, and candidate database 1050, may receive content and other data via input/output (hereinafter “I/O”) paths. The one or more components of the ML system 1010, the user interface 1030, the requisition database 1040 and/or the candidate database 1050 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the ML system 1010, the user interface 1030, the requisition database 1040 and the candidate database 1050 may have neither user input interface nor displays and may instead receive and display content using another device (e.g., a dedicated display device such as a computer screen and/or a dedicated input device such as a remote control, mouse, voice input, etc.). Additionally, the devices in computing system 1000 may run an application (or another suitable program). The application may cause the processors and other control circuitry to perform operations related to weighting training data (e.g., to increase the efficiency of training and performance of one or more machine-learning models described herein).

One or more components or devices in the computing system 1000 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically, magnetically, or optically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 10 also includes a network 1020. The network 1020 may be the Internet, a mobile phone network, a mobile voice or data network (e.g., a 5G or LTE network), a cable network, a public switched telephone network, a combination of these networks, or other types of communications networks or combinations of communications networks. The devices in FIG. 10 (e.g., ML system 1010, the user interface 1030, the requisition database 1040 and/or the candidate database 1050) may communicate (e.g., with each other or other computing systems not shown in FIG. 1) via the network 1020 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 10 may include additional communication paths linking hardware, software, and/or firmware components operating together. For example, the ML system 1010, any component of the ML system 1010 (e.g., the communication subsystem 1012 or the ML subsystem 1014), the user interface 1030, the requisition database 1040 and/or the candidate database 1050 may be implemented by one or more computing platforms.

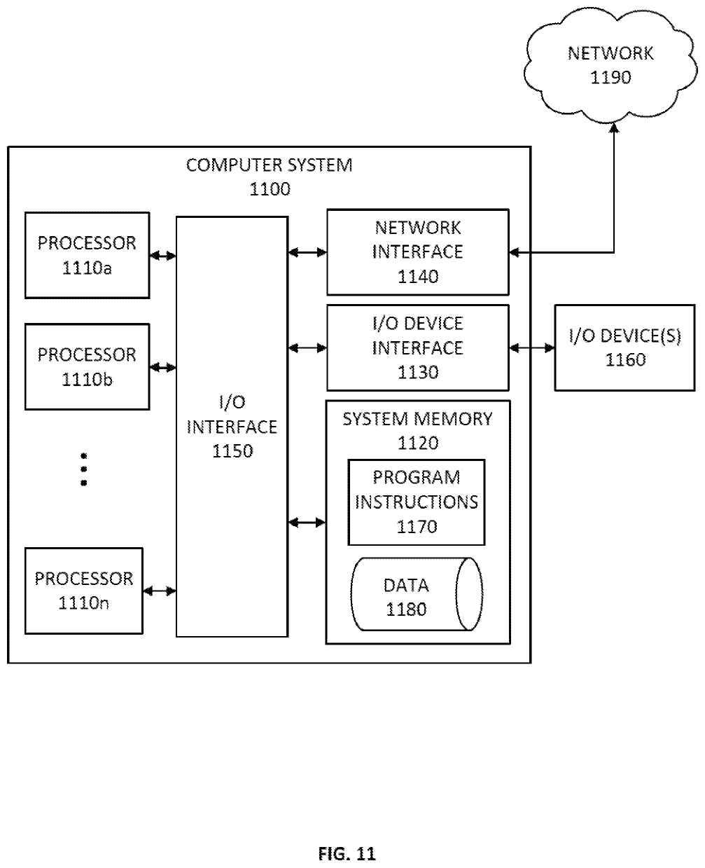

FIG. 11 is a diagram that illustrates an example computing system 1100 that may be used to implement one or more embodiments. Various portions of systems and methods described herein, may include or be executed on one or more computer systems similar to computing system 1100. Further, processes and modules described herein may be executed by one or more processing systems similar to that of computing system 1100.

Computing system 1100 may include one or more processors (e.g., processors 1110a-1110n) coupled to system memory 1120, an input/output I/O device interface 1130, and a network interface 1140 via an input/output (I/O) interface 1150. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1100. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1120). Computing system 1100 may be a units-processor system including one processor (e.g., processor 1110a), or a multi-processor system including any number of suitable processors (e.g., 1110a-1110n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1100 may include a plurality of computing devices (e.g., distributed computer systems) to implement various processing functions.

I/O device interface 1130 may provide an interface for connection of one or more I/O devices 1160 to computing system 1100. I/O devices may include devices that receive input (e.g., from a user) or output information (e.g., to a user). I/O devices 1160 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1160 may be connected to computing system 1100 through a wired or wireless connection. I/O devices 1160 may be connected to computing system 1100 from a remote location. I/O devices 1160 located on remote computer system, for example, may be connected to computing system 1100 via a network 1190 and network interface 1140.

Network interface 1140 may include a network adapter that provides for connection of computing system 1100 to a network 1190. Network interface 1140 may facilitate data exchange between computing system 1100 and other devices connected to the network 1190. Network interface 1140 may support wired or wireless communication. The network 1190 may include an electronic communication network, such as the Internet, a local area network (LAN), a wide area network (WAN), a cellular communications network, or the like.

System memory 1120 may be configured to store program instructions 1170 or data 1180. Program instructions 1170 may be executable by a processor (e.g., one or more of processors 1110a-1110n) to implement one or more embodiments of the present techniques. Instructions 1170 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1120 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 1120 may include a non-transitory computer readable storage medium that may have program instructions stored thereon that are executable by a computer processor (e.g., one or more of processors 1110a-1110n) to cause the subject matter and the functional operations described herein. A memory (e.g., system memory 1120) may include a single memory device and/or a plurality of memory devices (e.g., distributed memory devices).

I/O interface 1150 may be configured to coordinate I/O traffic between processors 1110a-1110n, system memory 1120, network interface 1140, I/O devices 1160, and/or other peripheral devices. I/O interface 1150 may perform protocol, timing, or other data transformations to convert data signals from one component (e.g., system memory 1120) into a format suitable for use by another component (e.g., processors 1110a-1110n). I/O interface 1150 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1100 or multiple computing systems 1100 configured to host different portions or instances of embodiments. Multiple computing systems 1100 may provide for parallel or sequential processing/execution of one or more portions of the techniques described herein.

Those skilled in the art will appreciate that computing system 1100 is merely illustrative and is not intended to limit the scope of the techniques described herein. Computing system 1100 may include any combination of devices or software that may perform or otherwise provide for the performance of the techniques described herein. For example, computing system 1100 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1100 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1100 may be transmitted to computing system 1100 via transmission media or signals such as electrical, electromagnetic, or digital signals, conveyed via a communication medium such as network 1190 or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

The present techniques will be better understood when read in view of the following enumerated embodiments:
1. A method for providing job requisitions, the method comprising: determining, by a candidate-requisition matching system and based on a machine learning model, a measure of outcome success for a set of job requisitions, the machine learning model trained to determine measures of outcome success for job requisitions based on a set of job requisition training data comprising: a set of historical job requisitions; and job outcomes for the set of historical job requisitions; ranking, by the candidate-requisition matching system and based on the measure of outcome success, the set of job requisitions to generate a ranked set of job requisitions; and providing, by the candidate-requisition matching system to a job candidate, one or more job requisitions of the ranked set of job requisitions for selection of a job requisition for application by the job candidate.
2. The method of embodiment 1, further comprising: determining, by the candidate-requisition matching system selection of a job requisition of the ranked set of job requisitions by the job candidate; and submitting, by a candidate-requisition matching system responsive to selection of the job requisition of the ranked set of job requisitions by the job candidate, an application for the job candidate for the job requisition selected.
3. The method of embodiment 2, wherein the job candidate is employed at a job corresponding to the job requisition selected based on the application for the job candidate for the job requisition selected.
4. The method of any one of embodiments 1 to 3, wherein the set of job requisition training data comprises job requisition ages for the job requisitions of the set of historical job requisitions, wherein the machine learning model is trained to determine measures of outcome success based on the job requisition ages of the job requisitions, and wherein the set of requisitions are ranked based on job requisition ages.
5. The method of any one of embodiments 1 to 4, wherein the job outcomes comprise job offers for the set of historical job requisitions.
6. The method of any one of embodiments 1 to 4, wherein the job outcomes comprise job offers accepted for the set of historical job requisitions.
7. The method of any one of embodiments 1 to 6, wherein the set of job requisitions comprises job requisitions for short-term employment.
8. The method of embodiment 7, wherein the set of job requisitions comprise job requisitions for short-term nursing jobs.
9. The method of any one of embodiments 1 to 8, further comprising: training the machine learning model to determine the measures of outcome success for the set of job requisitions based on the set of job requisition training data.
10. The method of embodiment 9, wherein the set of requisition training data further comprises requisition parameters for the set of historical job requisitions, wherein the requisition parameters comprise one or more of the following: requisition age, facility offer rate, number of views for requisition, and number of open positions for requisition.
11. The method of any one of embodiments 1 to 10, further comprising: determining a set of job candidates; matching, by the candidate-requisition matching system based on the ranked set of job requisitions, candidates of the set of job candidates to one or more job requisitions of the set of job requisitions, the matching comprising: matching, by the candidate-requisition matching system, the job candidate to the one or more job requisitions of the ranked set of job requisitions; and matching, by the candidate-requisition matching system, a second job candidate to one or more second job requisitions of the ranked set of job requisitions; and providing, by the candidate-requisition matching system, the one or more second job requisitions to the second job candidate for application by the second job candidate.
12. The method of any one of embodiments 1 to 11, further comprising: determining, by the candidate-requisition matching system and based on a second machine learning model, a measure of outcome success for a given job candidate and a given job requisition of the set of job requisitions, wherein the second machine learning model is trained to determine, based on a second set of job requisition training data, a second measure of outcome success for a candidate for a job requisition, the second set of job requisition training data comprising: a second set of historical job requisitions; candidate information for the second set of historical job requisitions; and candidate outcomes for the second set of historical job requisitions.
13. The method of embodiment 12, wherein the machine learning model comprises the second machine learning model.
14. The method of embodiment 12 or 13, further comprising: determining whether the measure of second outcome success satisfies a threshold value of outcome success; and in response to determining that the second measure of outcome success satisfies the threshold value of outcome success, providing, by the candidate-requisition matching system to the given job candidate, the given job requisition.
15. The method of any one of embodiments 12 to 14, further comprising: determining, by the candidate-requisition matching system and based on the second machine learning model, respective measures of outcome success for a second given job candidate for a second set of job requisitions; and ranking, by the candidate-requisition matching system and based on the respective measure of outcome success, the job requisitions of the second set of requisitions for the second given job candidate.
16. The method of embodiment 15, further comprising providing the ranking of the job requisitions of the second set of job requisitions to the second given job candidate or a job candidate pool comprising the second given job candidate.
17. The method of any one of embodiments 12 to 16, further comprising: determining, based on the measure of outcome success for the given job candidate and the given job requisition, a ranking of one or more job requisitions of the set of job requisitions; and providing the ranked set of job requisitions to the given job candidate.
18. The method of any one of embodiments 12 to 17, further comprising: training, by the candidate-requisition matching system, the second machine learning model to determine the second measure of outcome success for the given job candidate based on the second set of job requisition training data.
19. The method of embodiment 18, wherein the second set of job requisition training data further comprises candidate parameters for the set of historical job requisitions, wherein the candidate parameters comprise one or more of the following: candidate assignment status, candidate historical offer rate, and candidate historical acceptance rate.
20. The method of any one of embodiments 1 to 19, wherein the machine learning model comprises an ensemble of multiple machine learning models.
21. The method of any one of embodiments 1 to 20, wherein the machine learning model is trained based on optimization of a loss function.
22. The method of embodiment 21, wherein the machine learning model is trained based on gradient-based optimization of the loss function.
23. The method of any one of embodiments 1 to 22, wherein the machine learning model is trained iteratively.
24. The method of any one of embodiments 1 to 23, wherein the machine learning model is trained iteratively based on one or more updated sets of job requisition training data, wherein the one or more updated sets of job requisition training data comprise updated sets of job requisitions, the measure of outcome success for the updated sets of job requisitions determined, and candidate outcomes for the updated sets of job requisitions.
25. The method of any one of embodiments 1 to 24, wherein job outcomes comprise job outcomes for a set of historical job applications submitted for the historical job requisitions.
26. A non-transitory machine-readable storage medium having instructions stored thereon that are executable by a processor to cause the method operations of any one of embodiment 1 to 25.
27. A system comprising: a processor; and non-transitory machine-readable storage medium having instructions stored thereon that are executable by the processor to cause the method operations of any one of claims 1 to 25.
28. A method for providing job requisitions, the method comprising: determining, by an application-requisition ranking system and based on a machine learning model, a measure of outcome success for a set of job applications, the machine learning model trained to determine measures of outcome success for job applications based on a set of job application training data comprising: a set of historical job applications; and job outcomes for the set of historical job applications; ranking, by the application-requisition ranking system and based on the measure of outcome success, the set of job applications to generate a ranked set of job applications; and providing, by the application-requisition ranking system to a job requisitioner, one or more job application of the ranked set of job applications for selection of a job application for a job requisition by the job requisitioner.
29. The method of embodiment 28, further comprising: determining, by the application-requisition ranking system, selection of a job application of the ranked set of job applications by the job requisitioner; and submitting, by the application-requisition ranking system responsive to selection of the job application of the ranked set of job applications by the job requisitioner, a job candidate for the job requisition of the job application selected.
30. The method of embodiment 29, wherein the job candidate is employed at a job corresponding to the job requisition selected based on the job application of the job candidate selected for the job requisition.
31. The method of any one of embodiments 28 to 30, wherein the set of job application training data comprises job application outcomes for the job applications of the set of historical job applications, wherein the machine learning model is trained to determine measures of outcome success based on the job application outcomes of the job applications.
32. The method of any one of embodiments 28 to 31, wherein the job outcomes comprise job offers for the set of historical job applications.
33. The method of any one of embodiments 28 to 32, wherein the job outcomes comprise job offers accepted for the set of historical job applications.
34. The method of any one of embodiments 28 to 33, wherein the set of job applications comprises job applications for short-term work.
35. The method of any one of embodiments 28 to 34, wherein the set of job applications comprise job applications for short-term nursing jobs.
36. The method of any one of embodiments 28 to 35, further comprising:
training the machine learning model to determine the measures of outcome success for the set of job applications based on the set of job application training data.
37. The method of embodiment 36, wherein the set of job application training data further comprises application parameters for the set of historical job applications, wherein the application parameters comprise one or more of the following: requisition age, facility offer rate, number of views for requisition, and number of open positions for requisition.
38. The method of any one of embodiments 28 to 37, wherein determining, by the application-requisition ranking system and based on a machine learning model, a measure of outcome success for a set of job applications comprises determining, by an application-candidate-requisition ranking system, a measure of outcome success for a set of job applications, the set of job application training data further comprising: candidate information for the set of historical job applications; wherein ranking the set of job applications comprises ranking, by the application-candidate-requisition ranking system and based on the measure of outcome success, the set of job applications to generate a ranked set of job applications; and wherein providing one or more job application comprise providing, by the application-candidate-requisition ranking system to a job requisitioner, one or more job application of the ranked set of job applications for selection of a job candidate corresponding to a job application for a job requisition by the job requisitioner.
39. The method of any one of embodiments 28 to 38, further comprising: determining, by an application-candidate-requisition ranking system and based on a second machine learning model, a measure of outcome success for a given job application of the set of job applications corresponding to a given job candidate for a given job requisition, wherein the second machine learning model is trained to determine, based on a second set of job application training data, a second measure of outcome success for an application for a job requisition, the second set of job application training data comprising: a second set of historical job applications; candidate information for the second set of historical job applications; and candidate outcomes for the second set of historical job applications.
40. The method of embodiment 39, wherein the machine learning model comprises the second machine learning model.
41. The method of embodiment 39 or 40, further comprising:
determining whether the measure of second outcome success satisfies a threshold value of outcome success; and in response to determining that the second measure of outcome success satisfies the threshold value of outcome success, providing, by the application-candidate-requisition ranking system to a given job requisitioner, the given job application.
42. The method of any one of embodiments 39 to 41, further comprising: determining, by the application-candidate-requisition ranking system and based on the second machine learning model, respective measures of outcome success for a second given job application of the set of job applications corresponding to a second given job candidate for a second given job requisition; and ranking, by the application-candidate-requisition ranking system and based on the respective measures of outcome success, the job applications for the second given job requisition.
43. The method of any one of embodiments 39 to 42, further comprising: determining, based on the measure of outcome success for given job applications for a given job requisition, a ranking of one or more job applications of the set of job applications; and providing the ranked set of job applications to a given job requisitioner of the given job requisition.
44. The method of any one of embodiments 39 to 43, further comprising:
training, by the application-candidate-requisition ranking system, the second machine learning model to determine the second measure of outcome success for a given application corresponding to a given job candidate based on the second set of job application training data.
45. The method of embodiment 44, wherein the second set of job application training data further comprises candidate parameters for the set of historical job applications, wherein the candidate parameters comprise one or more of the following: candidate assignment status, candidate historical offer rate, and candidate historical acceptance rate.
46. The method of embodiment 28, wherein job outcomes comprise job outcomes for a set of historical job applications submitted for a set of historical job requisitions.
47. A non-transitory machine-readable storage medium having instructions stored thereon that are executable by a processor to cause the method operations of any one of embodiment 28 to 46.
48. A system comprising: a processor; and non-transitory machine-readable storage medium having instructions stored thereon that are executable by the processor to cause the method operations of any one of claims 28 to 46.

1. A method for providing job requisitions, the method comprising:
determining, by a candidate-requisition matching system and based on a machine learning model, a measure of outcome success for a set of job requisitions,
the machine learning model trained to determine measures of outcome success for job requisitions based on a set of job requisition training data comprising:
a set of historical job requisitions; and
job outcomes for the set of historical job requisitions;
ranking, by the candidate-requisition matching system and based on the measure of outcome success, the set of requisitions to generate a ranked set of requisitions; and
providing, by the candidate-requisition matching system to a job candidate, one or more job requisitions of the ranked set of job requisitions for selection of a job requisition for application by the job candidate.

2. The method of claim 1, further comprising:
determining, by the candidate-requisition matching system, selection of a job requisition of the ranked set of job requisitions by the job candidate; and
submitting, by a candidate-requisition matching system responsive to selection of the job requisition of the ranked set of job requisitions by the job candidate, an application for the job candidate for the job requisition selected.

3. The method of claim 2, wherein the job candidate is employed at a job corresponding to the job requisition selected based on the application for the job candidate for the job requisition selected.

4. The method of claim 1, wherein the set of job requisition training data comprises job requisition ages for the job requisitions of the set of historical job requisitions, wherein the machine learning model is trained to determine measures of outcome success based on the job requisition ages of the job requisitions, and wherein the set of job requisitions are ranked based on job requisition ages.

5. The method of claim 1, wherein the job outcomes comprise job offers for the set of historical job requisitions.

6. The method of claim 1, wherein the job outcomes comprise job offers accepted for the set of historical job requisitions.

7. The method of claim 1, wherein the set of job requisitions comprises job requisitions for short-term work.

8. The method of claim 1, wherein the set of job requisitions comprise job requisitions for short-term nursing jobs.

9. The method of claim 1, further comprising:
training the machine learning model to determine the measures of outcome success for the set of job requisitions based on the set of job requisition training data.

10. The method of claim 9, wherein the set of job requisition training data further comprises requisition parameters for the set of historical job requisitions, wherein the requisition parameters comprise one or more of the following: requisition age, facility offer rate, number of views for requisition, and number of open positions for requisition.

11. The method of claim 1, further comprising:
determining a set of job candidates;
matching, by the candidate-requisition matching system based on the ranked set of requisitions, candidates of the set of candidates to one or more job requisitions of the set of job requisitions, the matching comprising:
matching, by the candidate-requisition matching system, the job candidate to the one or more job requisitions of the ranked set of job requisitions; and
matching, by the candidate-requisition matching system, a second job candidate to one or more second job requisitions of the ranked set of job requisitions; and
providing, by the candidate-requisition matching system, the one or more second job requisitions to the second job candidate for application by the second job candidate.

12. The method of claim 1, further comprising:
determining, by the candidate-requisition matching system and based on a second machine learning model, a measure of outcome success for a given job candidate and a given job requisition of the set of job requisitions,
wherein the second machine learning model is trained to determine, based on a second set of job requisition training data, a second measure of outcome success for a candidate for a job requisition, the second set of job requisition training data comprising:
a second set of historical job requisitions;
candidate information for the second set of historical job requisitions; and
candidate outcomes for the second set of historical job requisitions.

13. The method of claim 12, wherein the machine learning model comprises the second machine learning model.

14. The method of claim 12, further comprising:
determining whether the measure of second outcome success satisfies a threshold value of outcome success; and
in response to determining that the second measure of outcome success satisfies the threshold value of outcome success, providing, by the candidate-requisition matching system to the given job candidate, the given job requisition.

15. The method of claim 12, further comprising:
determining, by the candidate-requisition matching system and based on the second machine learning model, respective measures of outcome success for a second given job candidate for a second set of job requisitions; and
ranking, by the candidate-requisition matching system and based on the respective measures of outcome success, the job requisitions of the second set of job requisitions for the second given job candidate.

16. The method of claim 15, further comprising providing the ranking of the job requisitions of the second set of job requisitions to the second given job candidate or a job candidate pool comprising the second given job candidate.

17. The method of claim 12, further comprising:
determining, based on the measure of outcome success for the given job candidate and the given job requisition, a ranking of one or more job requisitions of the set of job requisitions; and
providing the ranked set of job requisitions to the given job candidate.

18. The method of claim 12, further comprising:
training, by the candidate-requisition matching system, the second machine learning model to determine the second measure of outcome success for the given job candidate based on the second set of job requisition training data.

19. The method of claim 18, wherein the second set of job requisition training data further comprises candidate parameters for the set of historical job requisitions, wherein the candidate parameters comprise one or more of the following: candidate assignment status, candidate historical offer rate, and candidate historical acceptance rate.

20. The method of claim 1, wherein the machine learning model comprises an ensemble of multiple machine learning models.

21. The method of claim 1, wherein the machine learning model is trained based on optimization of a loss function.

22. The method of claim 21, wherein the machine learning model is trained based on gradient-based optimization of the loss function.

23. The method of claim 1, wherein the machine learning model is trained iteratively.

24. The method of claim 1, wherein the machine learning model is trained iteratively based on one or more updated sets of job requisition training data, wherein the one or more updated sets of job requisition training data comprise updated sets of job requisitions, the measure of outcome success for the updated sets of job requisitions determined, and candidate outcomes for the updated sets of job requisitions.

25. The method of claim 1, wherein job outcomes comprise job outcomes for a set of historical job applications submitted for the set of historical job requisitions.

26. A non-transitory machine-readable storage medium having instructions stored thereon that are executable by a processor to cause the following operations for providing job requisitions:
determining, based on a machine learning model, a measure of outcome success for a set of job requisitions,
the machine learning model trained to determine measures of outcome success for job requisitions based on a set of job requisition training data comprising:
a set of historical job requisitions; and
job outcomes for the set of historical job requisitions;
ranking, based on the measure of outcome success, the set of job requisitions to generate a ranked set of job requisitions; and
providing, to a job candidate, one or more job requisitions of the ranked set of job requisitions for selection of a job requisition for application by the job candidate.

27. A system comprising:
a processor; and
non-transitory machine-readable storage medium having instructions stored thereon that are executable by the processor to cause the following operations for providing job requisitions:
determining, based on a machine learning model, a measure of outcome success for a set of job requisitions,
the machine learning model trained to determine measures of outcome success for job requisitions based on a set of job requisition training data comprising:
a set of historical job requisitions; and
job outcomes for the set of historical job requisitions;
ranking, based on the measure of outcome success, the set of job requisitions to generate a ranked set of job requisitions; and
providing, to a job candidate, one or more job requisitions of the ranked set of job requisitions for selection of a job requisition for application by the job candidate.

28. A method for providing job requisitions, the method comprising:
determining, by an application-requisition ranking system and based on a machine learning model, a measure of outcome success for a set of job applications,
the machine learning model trained to determine measures of outcome success for job applications based on a set of job application training data comprising:
a set of historical job applications; and
job outcomes for the set of historical job applications;
ranking, by the application-requisition ranking system and based on the measure of outcome success, the set of job applications to generate a ranked set of job applications; and
providing, by the application-requisition ranking system to a job requisitioner, one or more job application of the ranked set of job applications for selection of a job application for a job requisition by the job requisitioner.

29. The method of claim 28, further comprising:
determining, by the application-requisition ranking system, selection of a job application of the ranked set of job applications by the job requisitioner; and
submitting, by the application-requisition ranking system responsive to selection of the job application of the ranked set of job applications by the job requisitioner, a job candidate for the job requisition of the job application selected.

30. The method of claim 29, wherein the job candidate is employed at a job corresponding to the job requisition selected based on the job application of the job candidate selected for the job requisition.

31. The method of claim 28, wherein the set of job application training data comprises job application outcomes for the job applications of the set of historical job applications, wherein the machine learning model is trained to determine measures of outcome success based on the job application outcomes of the job applications.

32. The method of claim 28, wherein the job outcomes comprise job offers for the set of historical job applications.

33. The method of claim 28, wherein the job outcomes comprise job offers accepted for the set of historical job applications.

34. The method of claim 28, wherein the set of job applications comprises job applications for short-term work.

35. The method of claim 28, wherein the set of job applications comprise job applications for short-term nursing jobs.

36. The method of claim 28, further comprising:
training the machine learning model to determine the measures of outcome success for the set of job applications based on the set of job application training data.

37. The method of claim 36, wherein the set of job application training data further comprises application parameters for the set of historical job applications, wherein the application parameters comprise one or more of the following: requisition age, facility offer rate, number of views for requisition, and number of open positions for requisition.

38. The method of claim 28, wherein determining, by the application-requisition ranking system and based on a machine learning model, a measure of outcome success for a set of job applications comprises determining, by an application-candidate-requisition ranking system, a measure of outcome success for a set of job applications,
the set of job application training data further comprising:
candidate information for the set of historical job applications;
wherein ranking the set of job applications comprises ranking, by the application-candidate-requisition ranking system and based on the measure of outcome success, the set ofjob applications to generate a ranked set of job applications; and
wherein providing one or more job application comprise providing, by the application-candidate-requisition ranking system to a job requisitioner, one or more job application of the ranked set of job applications for selection of a job candidate corresponding to a job application for a job requisition by the job requisitioner.

39. The method of claim 28, further comprising:
determining, by an application-candidate-requisition ranking system and based on a second machine learning model, a measure of outcome success for a given job application of the set of job applications corresponding to a given job candidate for a given job requisition, wherein the second machine learning model is trained to determine, based on a second set of job application training data, a second measure of outcome success for an application for a job requisition,
the second set of job application training data comprising:
a second set of historical job applications;
candidate information for the second set of historical job applications; and
candidate outcomes for the second set of historical job applications.

40. The method of claim 39, wherein the machine learning model comprises the second machine learning model.

41. The method of claim 39, further comprising:
determining whether the measure of second outcome success satisfies a threshold value of outcome success; and
in response to determining that the second measure of outcome success satisfies the threshold value of outcome success, providing, by the application-candidate-requisition ranking system to a given job requisitioner, the given job application.

42. The method of claim 39, further comprising:
determining, by the application-candidate-requisition ranking system and based on the second machine learning model, respective measures of outcome success for a second given job application of the set of job applications corresponding to a second given job candidate for a second given job requisition; and
ranking, by the application-candidate-requisition ranking system and based on the respective measures of outcome success, the job applications for the second given job requisition.

43. The method of claim 39, further comprising:
determining, based on the measure of outcome success for given job applications for a given job requisition, a ranking of one or more job applications of the set of job applications; and
providing the ranked set of job applications to a given job requisitioner of the given job requisition.

44. The method of claim 39, further comprising:
training, by the application-candidate-requisition ranking system, the second machine learning model to determine the second measure of outcome success for a given application corresponding to a given job candidate based on the second set of job application training data.

45. The method of claim 44, wherein the second set of job application training data further comprises candidate parameters for the set of historical job applications, wherein the candidate parameters comprise one or more of the following: candidate assignment status, candidate historical offer rate, and candidate historical acceptance rate.

46. The method of claim 28, wherein job outcomes comprise job outcomes for a set of historical job applications submitted for a set of historical job requisitions.
